(19) United States
(12) Patent Application Publication
(10) Pub. No.: US 2026/0099855 A1
(43) Pub. Date: Apr. 9, 2026

(54) AI-Enhanced Provenance, Decentralized Authenticity, and Royalties Ecosystem

(71) Applicant: CrownX, Houston, TX (US)

(72) Inventors: Raul C. Sanchez, Houston, TX (US); Henry Cordova, II, Houston, TX (US)

(73) Assignee: CrownX, Houston, TX (US)

(21) Appl. No.: 19/353,589

(22) Filed: Oct. 8, 2025

Related U.S. Application Data
(60) Provisional application No. 63/704,633, filed on Oct. 8, 2024.

(51) Int. Cl. G06Q 30/018; G06Q 50/18

(52) U.S. Cl. CPC G06Q 30/0185; G06Q 50/184

(57) ABSTRACT

Systems and methods are provided for authenticating, verifying, and tracking physical and digital assets through an integrated framework combining artificial intelligence, multi-sensor fusion, blockchain provenance, and quantum-secure processing. The system establishes a continuous provenance loop where real-time live capture, multi-sensor scanning, and expanded identifiers are analyzed by an AI decision engine to generate a unique multi-modal fingerprint.

This fingerprint is encoded into one or more machine-readable identifiers immutably recorded on a blockchain ledger. A Genesis Certificate of Authenticity (COA) anchors the item's origin, ownership, and transfer history. Subsequent resales or transfers trigger smart contracts that automate royalty distribution and provenance updates. The value captured through these processes can be monetary, such as currency or royalties, or intrinsic, such as positive social impact derived from verified actions or good deeds. Quantum acceleration enhances pattern matching, anomaly detection, and cryptographic resilience across industries.

### CROSS-REFERENCE TO RELATED APPLICATION

This application claims priority to U.S. Provisional Application No. 63/704,633 filed Oct. 8, 2024, the disclosure of which is incorporated by reference herein in its entirety.

### TECHNICAL FIELD

The present invention relates generally to systems and methods for authenticating and tracking information across a variety of industries.

### BACKGROUND

Memorabilia refers to objects or items that hold sentimental or historical significance, often linked to a specific event, person, or time. These items are collected for the memories they evoke, rather than their intrinsic value. Memorabilia can take many forms, ranging from signed photographs, concert tickets, and sports jerseys to personal letters, autographs, and rare collectibles. What makes them special is not just their uniqueness, but also the stories they carry—whether it's a souvenir from a historical event or a personal keepsake from a beloved artist or athlete.

One of the most popular types of memorabilia is sports-related, where items like game-worn jerseys, signed balls, or even equipment used in iconic matches are highly prized. Fans seek these pieces as a way to connect more deeply with their favorite teams or athletes, reliving moments of victory or admiration. Similarly, music and movie memorabilia have a huge following, where collectors hunt for original concert posters, instruments, or costumes worn in famous films. The rarity of these items often adds to their allure, as owning a piece of history from a memorable cultural moment can evoke a sense of pride and nostalgia.

In addition to personal enjoyment, memorabilia also holds investment potential. Many collectors value these items not just for their emotional connection but also for their ability to appreciate in value over time. Items linked to major events or iconic individuals often see substantial price increases, especially when the items are well-preserved and authenticated.

Memorabilia also serves as a way to preserve and share history with future generations. Museums and private collectors often curate vast collections of memorabilia to help tell the stories of significant cultural, political, or sporting events. These items provide a window into the past, allowing people to gain a deeper understanding of specific moments in history. For instance, artifacts from world wars, vintage movie posters, or signed documents from influential figures all contribute to the collective memory of a society.

Royalties on memorabilia are a form of compensation paid to the individuals or entities that hold the intellectual property (IP) rights over the items being sold. These royalties come into play when memorabilia features copyrighted material, such as images of celebrities, sports teams'logos, or signatures that are legally protected. For instance, if a company produces a limited-edition poster with a famous athlete's image or autograph, they must usually pay royalties to that athlete or their estate, as it falls under the use of their likeness. This system ensures that the creators, athletes, or celebrities involved in producing value continue to benefit from the commercialization of their name and brand.

One significant area where royalties are common involves sports memorabilia. Professional leagues, such as the NFL, NBA, or MLB, often license their teams'logos and players'likenesses to companies that produce merchandise like jerseys, trading cards, or signed equipment. The teams, leagues, and players then receive a percentage of the profits from sales as royalties. This system ensures that the intellectual property rights of players and teams are respected, and they are compensated for the use of their brand, even long after they've retired from the game.

Royalties also play a key role in entertainment memorabilia, particularly when it involves famous actors, musicians, or films. Items like signed movie posters, instruments used in concerts, or film props often require permission and licensing fees before they can be legally sold, especially in cases where the image or name of a deceased celebrity is used. Estates of famous individuals, such as Elvis Presley or Marilyn Monroe, continue to collect royalties from memorabilia sales, ensuring that their brands remain profitable and protected even after their passing. This legal framework is crucial to maintaining the control and legacy of celebrities'public image.

In some cases, royalties on memorabilia can also become a point of legal dispute. There have been instances where individuals or companies have attempted to sell memorabilia without properly compensating the rightful owners of the intellectual property. Such disputes often end up in court, where royalties are assessed and sometimes retroactively awarded. This emphasizes the importance of clear legal agreements in the memorabilia industry, ensuring that all parties benefit fairly from the sale of items linked to significant public figures or cultural moments.

Despite the existence of systems meant to compensate celebrities, athletes, and other public figures for the use of their likeness, there are significant problems with many of them actually receiving fair royalties. One common issue is that many contracts, especially older ones, do not either include provisions for royalties or include terms that are extremely unfavorable to the individual. For example, athletes from earlier generations may have signed contracts before the importance of intellectual property was fully understood, leaving them with little or no claim to royalties on memorabilia featuring their name or image. Even in modern times, younger or less experienced celebrities may sign deals without fully understanding the long-term implications, resulting in lost earnings over time.

Another problem arises from the exploitation of celebrities'likenesses without proper compensation, particularly posthumously. Estates of deceased stars, such as musicians, actors, or athletes, often face challenges in securing rightful royalties as some entities may try to use their image or name without seeking proper permission. Additionally, there are instances where memorabilia are sold in secondary markets, like auction houses or third-party retailers, where the original celebrity or their estate receives no share of the profits. This loophole is especially unfair when high-value items, like autographed memorabilia or rare collectibles, fetch enormous sums without benefitting the person who made them valuable in the first place.

The issue is further complicated by unauthorized merchandise, such as counterfeit memorabilia, which floods the market and dilutes the value of legitimate items. This not only undermines the value of authentic memorabilia but also deprives athletes and celebrities of their rightful earnings. Many public figures have to take legal action to combat counterfeiters, which can be costly and time-consuming. The lack of comprehensive enforcement of intellectual property laws makes it even harder for athletes and celebrities to secure royalties for memorabilia sold without their approval.

This situation is inherently unfair because the individuals who helped create the value behind the memorabilia are often left out of the profits. Without the performances, achievements, or persona of these public figures, there would be no demand for these items. The current gaps in the royalties system fail to recognize their essential role in generating this value. In a fairer system, athletes, celebrities, and their estates would have more control over how their likeness is used and would consistently receive compensation for it, ensuring that they benefit from their enduring popularity and legacy.

One of the biggest challenges facing originators of memorabilia, art, and collectibles is the lack of standardization in how royalties are tracked and distributed. There is no universal system to ensure that creators are fairly compensated when their works are sold or resold. This lack of consistency means that different markets and platforms calculate royalties in various ways, often leading to discrepancies in how much money originators receive. As a result, some creators are underpaid or not paid at all for the use of their intellectual property. Another issue arises from the complexity of the resale market, which is fragmented across multiple platforms and intermediaries. Memorabilia, art, and collectibles frequently change hands in secondary markets, where tracking the sales of these items becomes increasingly difficult. The involvement of numerous parties, such as auction houses, online marketplaces, and private dealers, complicates the process of ensuring that originators receive their rightful share of profits. In many cases, royalties go unpaid because there is no clear system in place to track these transactions across different platforms.

Inadequate tracking systems further exacerbate the issue. Many existing systems for monitoring the sale and resale of memorabilia, art, and collectibles are outdated or insufficient for the modern market. As a result, the ownership history of items is often incomplete, making it hard to monitor when items are resold and whether the originator is due any royalties. These gaps in tracking leave originators vulnerable to lost income, as sales can go unnoticed or unreported.

Additionally, there is a lack of comprehensive legal protection to ensure that originators receive royalties. Many current laws and contracts do not adequately address how royalties should be paid, especially in cases of resale. This leaves creators, artists, and athletes exposed to exploitation, with limited legal recourse to recover unpaid royalties. The absence of clear legal frameworks means that originators often struggle to enforce their rights, particularly when dealing with secondary market sales.

Another key challenge is the lack of awareness among originators regarding their rights to royalties. Many creators may not fully understand how royalties work, or they might not be aware of the mechanisms available to enforce these rights. This lack of knowledge often results in missed opportunities, where creators could have secured royalties but did not know how to claim them. Educational efforts and better resources are needed to empower originators to protect their intellectual property and ensure fair compensation.

Counterfeiting is a significant problem that undermines trust in the memorabilia and collectibles market. Fake or counterfeit items flood the market, making it difficult for buyers and sellers to verify authenticity. This not only damages the reputation of the market but also prevents originators from receiving the royalties they deserve. When counterfeit items are sold, the rightful creators lose out on potential earnings, and the value of authentic items is diminished.

A lack of provenance, or clear ownership history, also hampers efforts to verify the legitimacy of items and ensure royalties are paid. Provenance is essential for establishing the authenticity of memorabilia, art, and collectibles, but when this chain of ownership is incomplete or unclear, it becomes difficult to track the lifecycle of an item. Without proper documentation, originators cannot claim royalties, and buyers cannot be sure they are purchasing genuine items, further complicating the market.

The absence of transparency in many transactions adds another layer of difficulty.

When items change hands without clear tracking or authentication systems in place, it becomes nearly impossible to monitor when and where royalties should be paid. This lack of transparency prevents fair compensation and leaves originators at a disadvantage. A robust system that can track the entire lifecycle of an item, from its creation to each resale, is crucial for ensuring that royalties are properly distributed.

The difficulty in verifying items due to the absence of proper authentication mechanisms leads to disputes over authenticity and rightful ownership. When items are not properly authenticated or tracked, fraudulent claims become more common, with individuals attempting to sell inauthentic memorabilia or collectibles. This not only damages the market but also prevents rightful originators from receiving royalties. Unrecorded transactions and fraudulent sales further skew the calculation of royalties, leaving originators undercompensated for their work.

Current name/Image/Likness (“NIL”) rights frameworks are fragmented and limited to contractual arrangements (e.g., athlete endorsements, influencer deals). Individuals receive no royalties for widespread use of their NIL on social media, news media, event coverage, advertisements, or community contributions. Fraudulent impersonations (e.g., deepfakes, manipulated media, or unauthorized likeness usage) further erode individual control over their personal identity. No system exists today that authenticates NIL in real time, secures it against quantum threats, and enforces royalty payments automatically across digital and physical ecosystems.

Financial institutions, investors, and regulators depend heavily on CPA-issued financial reports. However, fraud is pervasive: reports are often reused without authorization, peer reviews can conceal omissions, and CPAs rarely capture ongoing value when their work is repeatedly leveraged across funding and investment deals. Current systems lack real-time verification, immutable custody, or royalty mechanisms for CPA work products. Further, there is no automated verification that the CPA or firm preparing a report is properly licensed at the time of submission, creating risk for lenders, regulators, and investors.

Traditional payroll systems compensate employees via fixed wages or salaries, irrespective of real-time productivity, quality, or customer impact. Fraudulent time reporting, payroll disputes, and inefficiencies persist. Employees rarely share directly in the long-term value they help generate.

Inheritance disputes frequently arise due to uncertainty over the authenticity, provenance, or rightful ownership of family assets such as jewelry, watches, artworks, military medals, and vintage instruments. Conventional solutions rely on paper appraisals, wills, or receipts, which are subject to forgery or loss.

Insurance fraud involving high-value assets (e.g., jewelry, watches, collectibles, artworks) costs billions annually. Current methods rely on photos, receipts, or subjective appraisals that are prone to falsification and do not reliably capture an item's true condition over time.

Traditional donations of memorabilia or collectibles rely on subjective appraisals that may fluctuate or be disputed by tax authorities. Non-profits often sell donated items outright, receiving only a one-time benefit, while donors receive limited or uncertain tax deductions. There is no long-term linkage between the donated asset's future royalties and the donor's tax benefits.

The global art market suffers from pervasive fraud, forgery, and provenance disputes, costing billions annually. Paper-based Certificates of Authenticity (COAs) are easily falsified, while appraisals lack evidentiary rigor. Artists seldom benefit from resale royalties. Moreover, existing systems do not leverage quantum-enabled technologies to secure provenance against future computational threats.

Current fan engagement and licensing models suffer from several shortcomings. For example, sports fans may attend or watch historic moments but cannot prove verifiable ownership of highlight-related collectibles. Tickets lack long-term provenance and resale royalty structures. As related to the music industry, for example, concertgoers receive only transient experiences; recordings and memorabilia lack authenticated royalties for performers.

Considering aspects of gaming, for example, digital items (e.g., skins, avatars, achievements) are easily duplicated or hacked, with no enforceable provenance or resale royalties. In the field of literature/comics, for example, first editions, manuscripts, and original sketches lack tamper-proof authentication, and authors rarely benefit from ongoing royalties on secondary market resales.

### SUMMARY

The present invention is directed to authentication and tracking systems and methods. The authentication and tracking systems and methods advantageously address the aforementioned deficiencies by providing a solution harnessing artificial intelligence, blockchain technology, and smart contracts to authenticate and track items across a variety of industries. Thus, the aforementioned problems associated with the current lack of authentication and tracking are mitigated or avoided.

In one aspect of the present disclosure a system for authenticating assets and distributing royalties, includes a real-time capture module configured to record live creation, transfer, or performance events with an embedded geolocation and timestamp and a multi-sensor authentication module configured to generate a fused fingerprint hash of the asset or performance using optical, spectral, acoustic, biometric, or digital data. The system further includes a first Certificate of Authenticity linked to the fused fingerprint hash and configured for entry on a blockchain ledger. The first Certificate of Authenticity including at least one of a video recording of the live capture event, a multi-dimensional interactive model, and/or metadata including ownership lineage, valuation history, and/or royalty terms. The system also includes a quantum security module configured to protect the first Certificate of Authenticity, and/or the fused fingerprint hash, using quantum-accelerated pattern matching, quantum-powered anomaly detection, and/or quantum-enabled cryptography.

In another aspect of the present disclosure, the first asset comprises memorabilia authenticated by real-time live capture and the memorabilia includes autographed items, event-worn apparel, game-used equipment, and/or cultural artifacts.

In another aspect of the present disclosure, the first asset includes a collectible authenticated via multi-sensor scanning and blockchain provenance and the collectable includes trading cards, toys, figurines, and/or limited-edition merchandise.

In another aspect of the present disclosure, the first asset includes a visual artwork authenticated using optical, spectral, and/or structural analysis and the visual artwork includes a painting, a drawing, a print, a sculpture, a ceramic, a photograph, and/or or a textile artwork.

In another aspect of the present disclosure,

In another aspect of the present disclosure, the first asset includes a fashion work authenticated via weave pattern imaging, dye spectral scanning, and/or RFID/NFC tagging and the fashion work includes apparel, footwear, handbags, accessories, and/or couture pieces.

In another aspect of the present disclosure, the first asset includes a luxury good authenticated via micro-engraving, optical variable ink, and/or material resonance profiling and the luxury good includes jewelry, watches, furniture, or interior design objects.

In another aspect of the present disclosure, the system further includes a smart contract engine configured to automatically distribute royalties upon resale, licensing, or usage of the first asset.

In another aspect of the present disclosure, the quantum security module is configured to protect royalty transactions.

In another aspect of the present disclosure, the first certificate of authenticity is linked to a sports highlight, the sports highlight includes plays, scores, and/or ticketed events, and the royalties are distributed to athletes, teams, or leagues upon resale and/or a licensed replay.

In another aspect of the present disclosure, the first certificate of authenticity is linked to a music performance, the music performance includes a live concert, studio recording, and/or signed instrument, and royalties are distributed to an originator and/or an estate of the originator upon resale and/or reuse.

In another aspect of the present disclosure, the first certificate of authenticity is linked to the first asset, the first asset comprises a gaming and/or e-sports asset authenticated using server logs and/or player credentials, and the gaming and/or e-sport asset includes digital skins, avatars, in-game achievements, and/or recorded highlight reels.

In another aspect of the present disclosure, the first certificate of authenticity is linked to the first asset, the first asset comprise a literary or comic work authenticated using multi-spectral imaging and author signature capture, and the literary or comic work includes a manuscript, a first edition, a novel, and/or an original illustration.

In another aspect of the present disclosure, the first certificate of authenticity further comprises a valuation history, including prior sale prices, appraisals, and/or insurance claims associated with the authenticated asset.

In another aspect of the present disclosure, royalties are distributed for a lifetime of an originator and extended posthumously to heirs, estates, and/or designated beneficiaries.

In another aspect of the present disclosure, the first certificate of authenticity further comprises ownership lineage, including current and prior owners, transfers, and/or inheritance-linked provenance records.

In another aspect of the present disclosure, access to the first certificate of authenticity is controlled by cryptographic keys configured to display simplified confirmations to a public user and to display full provenance details to an authorized user.

In another aspect of the present disclosure, the first certificate of authenticity further comprises gamification features, including unlockable augmented reality experiences, virtual reality experiences, leaderboard rankings, and/or tiered membership benefits.

In another aspect of the present disclosure, a method of authenticating assets and distributing royalties includes capturing, in real time, a creation or a transfer of a first asset or a first performance, performing multi-sensor scanning of the first asset or the first performance, generating a fingerprint hash, creating a first certificate of authenticity linked to the fingerprint hash, wherein the first certificate of authenticity includes video, a three-dimensional or four-dimensional model, metadata including ownership lineage, a valuation history, and/or a royalty structure, storing the first certificate of authenticity on a blockchain ledger and securing the first certificate of authenticity and/or the fingerprint hash using quantum-accelerated pattern matching, anomaly detection, and/or cryptography.

In another aspect of the present disclosure, the method further includes executing a smart contract to distribute royalties upon resale, licensing, and/or usage of the first asset or the first performance and generating a royalty record. The securing the first certificate of authenticity and/or the fingerprint hash further includes securing the royalty record.

In another aspect of the present disclosure, computing device includes a processor and a memory configured to store programming instructions, wherein the programming instructions, when executed by the processor, are configured to cause the processor to cooperate with one or more devices to capture, in real time, a creation or a transfer, of a first asset or a first performance, scan the first asset or first performance using a plurality of sensors, generate a fingerprint hash, create a first certificate of authenticity including video, a multi-dimensional model, metadata including ownership lineage, valuation history, and/or royalty structure, store the first certificate of authenticity on a blockchain ledger and secure the first certificate of authenticity and/or the fingerprint hash using quantum-accelerated pattern matching, anomaly detection, and cryptography.

In another aspect of the present disclosure, the programming instructions, when executed by the processor, are further configured to cause the processor to cooperate with the one or more devices execute a smart contract to distribute royalties upon resale, licensing, and/or usage of the first asset and generate a royalty record, wherein the royalty record is secured using quantum-accelerated pattern matching, anomaly detection, and cryptography.

In another aspect of the present disclosure, a method of authenticating an individual's name, image, and likeness (NIL), includes capturing a first NIL that includes biometric data obtained using a plurality of sensors, generating a first certificate of authenticity associated with the first NIL, entering the first certificate of authenticity as an entry on a blockchain ledger, identifying use of the first NIL across digital and/or physical platforms, and distributing royalties to an originator by executing a smart contract.

In another aspect of the present disclosure, the method further includes using quantum-accelerated multi-sensor pattern matching when identifying use of the first NIL.

In another aspect of the present disclosure, the method further includes determining fraudulent use of the first NIL with quantum-powered anomaly detection.

In another aspect of the present disclosure, the method further includes securing the blockchain ledger and/or smart contracts with quantum-enabled cryptographic algorithms.

In another aspect of the present disclosure, the method further includes distributing royalties throughout a lifetime of the originator and assigning rights to the royalties posthumously.

In another aspect of the present disclosure, a method of authenticating and monetizing professional-generated reports includes obtaining information about a first report generated by a professional, verifying a first license associated with a professional against a regulatory authority database, extracting text and numerical data from the first license using artificial intelligence, generating a blockchain ledger entry using metadata associated with the first license and/or a digital signature and producing a blockchain-linked first certificate of authenticity.

In another aspect of the present disclosure, the method further includes executing a smart contract to distribute royalty payments to the professional upon verified use of the first report.

In another aspect of the present disclosure, the method further includes accessing the blockchain ledger entry associated with the first report.

In another aspect of the present disclosure, accessing the blockchain ledger entry associated with the first report occurs for peer review.

In another aspect of the present disclosure, the method further includes identifying duplicate use an/or unauthorized modification of the first report using AI-driven fraud detection.

In another aspect of the present disclosure, the method further includes securing the blockchain ledger and the metadata with quantum-resistant cryptographic schemes.

In another aspect of the present disclosure a method of compensating employees, includes authenticating labor contributions with artificial intelligence, generating a first certificates of authenticity associated with the labor contributions, recording the first certificates of authenticity as an entry on blockchain ledger, executing smart contracts that allocate royalties in proportion to the labor contributions, and securing the first certificate of authenticity with quantum-resistant cryptography.

In another aspect of the present disclosure, the method further includes replacing and/or supplementing wage-per-hour and/or salary payments with royalties.

In another aspect of the present disclosure the method further includes, validating sales commissions using on or more records associated with a CRM and/or a POS to prevent fraud.

In another aspect of the present disclosure, the method further includes authenticating manufacturing contributions using Internet of Things sensors and Artificial Intelligence before royalties are issued.

In another aspect of the present disclosure, the method further includes tokenizing aggregated contributions as a tradeable business output unit.

In another aspect of the present disclosure, a method of authenticating and gamifying cultural assets includes capturing a first asset or a first performance or a first creative work with embedded data using a plurality of sensors, generating a blockchain-linked first certificate of authenticity that includes interactive video and/or multi-dimensional representations associated with the first asset or the first performance or the first creative work, embedding ownership lineage, valuation history, and/or royalty terms within the blockchain-linked first certificate of authenticity, and providing interactive or gamified features accessible by holders of the blockchain-linked first certificate of authenticity.

In another aspect of the present disclosure, the method further includes linking the blockchain-linked first certificate of authenticity to a sports highlight, a ticket, a music performance, a gaming asset, or a literary work.

In another aspect of the present disclosure, the method further includes executing a smart contract to distribute royalties upon resale or licensing of the first asset or the first performance or the first creative work associated with the blockchain-linked first certificate of authenticity.

In another aspect of the present disclosure, the method further includes authenticating the first asset or the first performance or the first creative work associated with the blockchain-linked first certificate of authenticity using quantum-accelerated pattern matching against known works.

In another aspect of the present disclosure, the method further includes enabling gamified experiences for a holder of the blockchain-linked first certificate of authenticity, wherein the gamified experiences include augmented reality replays, virtual reality replays, leaderboard participation, and/or exclusive content unlocks In another aspect of the present disclosure, a method of authenticating artworks includes capturing live video of a first asset with embedded timestamp and geolocation, scanning the first asset using a plurality of sensors, generating an interactive first certificate of authenticity. The first certificate of authenticity that includes a video, a multi-dimensional virtual model, ownership lineage, valuation history, and/or embedded royalty terms. The method also includes minting the first certificate of authenticity as a blockchain-linked artifact secured with quantum-resistant encryption.

In another aspect of the present disclosure, the method further includes scaling authentication using quantum-accelerated pattern matching.

In another aspect of the present disclosure, the method further includes identifying forgery attempts using quantum-powered anomaly detection, wherein the forgery attempts include pigment mismatch, structural alteration, and/or digital manipulation.

In another aspect of the present disclosure, the method further includes distributing royalties automatically using smart contracts, after a verified usage of the first asset, wherein resale, licensing, and/or exhibition.

In another aspect of the present disclosure, a system for authenticating assets and allocating royalties, includes an artificial intelligence (AI) module configured to activate a plurality of sensors based on classification of a first asset, a multi-sensor capture suite configured to obtain an identifier of the first asset, a processor configured to fuse the identifiers into a first multi-modal vector, a fingerprinting engine configured to generate an AI Fingerprint Hash using the first multi-modal vector, and a first certificate of authenticity linked to the AI Fingerprint Hash and configured for entry on a blockchain ledger. The system also includes a quantum security module that includes post-quantum cryptography, quantum-accelerated pattern matching, and/or anomaly detection. The system further includes a smart contract engine configured to automatically distribute royalties to one or more stakeholders after a transaction is verified.

In another aspect of the present disclosure, the identifier includes physical, digital, chemical, biological, and/or cryptographic characteristic of the first asset.

In another aspect of the present disclosure, the transaction includes transfer, resale, or usage of the asset.

In another aspect of the present disclosure, the first certificate of authenticity includes an interactive artifact.

In another aspect of the present disclosure, the artifact includes live capture video, metadata overlays, multi-sensor descriptors, and/or cryptographically sealed provenance anchors.

In another aspect of the present disclosure, the artifact is multi-dimensional and is accessible in augmented reality (AR) or virtual reality (VR) environment.

In another aspect of the present disclosure, the first certificate of authenticity further comprises unlockable gamified content that is gated by smart contracts tied to wallet authentication.

In another aspect of the present disclosure, the system further includes a marketplace engine configured to list authenticated assets and coins.

In another aspect of the present disclosure, the marketplace engine is configured to verify provenance of each listing and immutably record trades.

In another aspect of the present disclosure, the trades are recorded with blockchain anchoring and/or ISO 20022 settlement messages.

In another aspect of the present disclosure, the system further includes a coin authentication module configured to verify ecosystem coins by confirming cryptographic linkage to TokenID, royalty reserves, and/or codex-indexed audit entries.

In another aspect of the present disclosure, the system further includes a non-dilution module configured to restrict coin issuance to authenticated provenance and royalty inflows.

In another aspect of the present disclosure, the coin issuance is limited by a total supply configured to be cryptographically capped at a first limit.

In another aspect of the present disclosure, the system further includes an authentication module configured to authenticate IT logs, cybersecurity events, and compliance reports by generating provenance-linked AI Fingerprint Hashes, blockchain anchoring, and codex-indexed dual audit trails.

In another aspect of the present disclosure, the AI engine is configured to authenticate media files by detecting deepfake or synthetic alterations, comparing against provenance-captured biometric and sensor baselines, and recording results with blockchain anchoring

In another aspect of the present disclosure, a method of authenticating assets and allocating royalties includes initiating live capture of a first asset via one or more networked devices, activating a plurality of sensors as directed by an artificial intelligence (AI) module based on asset classification, capturing identifiers associated with the first asset, generating a first multi-modal vector, computing a first AI Fingerprint Hash using the first multi-modal vector, determining a provenance record, storing the first AI Fingerprint Hash and provenance record on a blockchain ledger secured by post-quantum cryptography, and executing a smart contract to allocate royalties upon transfer, resale, or usage of the first asset.

In another aspect of the present disclosure, capturing the identifiers associate with the first asset includes capturing identifiers across physical, digital, chemical, biological, and/or cryptographic modalities.

In another aspect of the present disclosure, the initiating live capture of a first asset via one or more networked devices further comprises receiving capture data from a wearable device, the wearable device including a fitness tracker, a bodycam, smart clothing, or a smart contact lens.

In another aspect of the present disclosure, the initiating live capture of a first asset via one or more networked devices further comprises receiving capture data from an unmanned aerial vehicle.

In another aspect of the present disclosure, the initiating live capture of a first asset via one or more networked devices further comprises receiving capture data from a robotic platform and/or a cobot.

In another aspect of the present disclosure, the initiating live capture of a first asset via one or more networked devices further comprises receiving capture data from an industrial inspection device (e.g., borescope, handheld scanner, spectrometer, XRF).

In another aspect of the present disclosure, the initiating live capture of a first asset via one or more networked devices further comprises receiving capture data from an Interne of Things (IoT) device (e.g., smart hub, voice assistant, appliance).

In another aspect of the present disclosure, the initiating live capture of a first asset via one or more networked devices further comprises receiving capture data from a gaming and/or entertainment device.

In another aspect of the present disclosure, the initiating live capture of a first asset via one or more networked devices further comprises receiving capture data from a vehicle sensor platform (e.g., ADAS, telematics, lidar/camera).

In another aspect of the present disclosure, the initiating live capture of a first asset via one or more networked devices further comprises receiving capture data from an autonomous delivery robot.

In another aspect of the present disclosure, the initiating live capture of a first asset via one or more networked devices further comprises receiving capture data from a medical imaging device (e.g., ultrasound, CT, MRI, handheld diagnostics).

In another aspect of the present disclosure, the initiating live capture of a first asset via one or more networked devices further comprises receiving capture data from a laboratory instrument (e.g., spectrometer, microscope, DNA sequencer).

In another aspect of the present disclosure, the initiating live capture of a first asset via one or more networked devices further comprises receiving capture data from a surveillance/smart city system.

In another aspect of the present disclosure, the initiating live capture of a first asset via one or more networked devices further comprises receiving capture data from a financial transaction device (e.g., ATM, kiosk, POS).

In another aspect of the present disclosure, the initiating live capture of a first asset via one or more networked devices further comprises receiving capture data from a networked infrastructure node (e.g., stadium, port, airport).

In another aspect of the present disclosure, the method further includes authenticating cyber incidents and forensic evidence by capturing digital signatures, anomaly patterns, and timestamps, and anchoring results to blockchain with quantum cryptography

In another aspect of the present disclosure, the method further includes authenticating news reports, trial evidence, or governmental communications by verifying provenance and detecting AI-generated manipulation, with results codex-indexed for judicial or public accountability.

In another aspect of the present disclosure, the method further includes authenticating foreign government communications, treaties, or proxy war financing events by capturing provenance data, generating AI Fingerprint Hashes, and anchoring dual blockchain and codex audit trails

In another aspect of the present disclosure, the method further includes authenticating coin supply integrity by validating that each minted coin is reserve-backed, provenance-linked, and codex-indexed to prevent dilution.

In another aspect of the present disclosure, the method further includes authenticating foreign government communications, treaties, or proxy war financing events by capturing provenance data, generating AI Fingerprint Hashes, and anchoring dual blockchain and codex audit trails

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a schematic diagram of an environment for an authentication and tracking system, according to one or more embodiments of the present disclosure;

FIG. 2 is a schematic diagram of the authentication and tracking system, according to one or more embodiments of the present disclosure;

FIG. 3 is a process flow diagram of an authentication and tracking method, according to one or more embodiments of the present disclosure; and

FIG. 4 is a process flow diagram of the authentication and tracking system illustrating a perks and rewards system, according to one or more embodiments of the present disclosure;

FIG. 5 is a process flow diagram depicting a Provenance Creation process, according to one or more embodiments of the present disclosure;

FIG. 6 is process flow diagram depicting a unified system architecture, according to one or more embodiments of the present disclosure;

FIG. 7 is a schematic diagram of an alternative embodiment of an authentication and tracking method that includes the provenance flow creation process, according to one or more embodiments of the present disclosure;

FIG. 8 is a process flow diagram of an exemplary method for authenticating and tracking biometric and/or name/Image/likeness (NIL) information using the authentication and tracking system, according to one or more embodiments of the present disclosure;

FIG. 9 is a process flow diagram of an exemplary method for authenticating and tracking CPA-certified financial report information using the authentication and tracking system, according to one or more embodiments of the present disclosure;

FIG. 10 is a process flow diagram of an exemplary method for authenticating and tracking employment compensation information using the authentication and tracking system, according to one or more embodiments of the present disclosure;

FIG. 11 is a process flow diagram of an exemplary method for authenticating and tracking heirloom and/or inheritance (i.e., bequest) information using the authentication and tracking system, according to one or more embodiments of the present disclosure;

FIG. 12 is a process flow diagram of an exemplary method for authenticating and tracking insurance and/or high-value asset information using the authentication and tracking system, according to one or more embodiments of the present disclosure;

FIG. 13 is a process flow diagram of an exemplary method for authenticating and tracking donation and/or non-profit information using the authentication and tracking system, according to one or more embodiments of the present disclosure;

FIG. 14 is a process flow diagram of an exemplary method for authenticating and tracking visual arts information using the authentication and tracking system, according to one or more embodiments of the present disclosure; and

FIG. 15 is a process flow diagram of an exemplary computer system architecture, according to one or more embodiments of the present disclosure.

### DETAILED DESCRIPTION

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

As used in this document, the singular form “a”, “an”, and “the” include plural references unless the context clearly dictates otherwise. Unless defined otherwise, all technical and scientific terms used herein have the same meaning as commonly understood by one of ordinary skill in the art. As used in this document, the term “comprising” means “including, but not limited to.”

The term “substantially,” when used in connection with a value, is intended to mean approximately, within a threshold tolerance that is a percentage corresponding to any of the percentages described in the previous paragraph. For example, items described as “substantially the same,” “substantially equal,” or “substantially planar,” may be exactly the same, equal, or planar, or may be the same, equal, or planar within acceptable variations that may occur, for example, due to manufacturing processes and/or tolerances.

This disclosure is not limited to the particular systems, methodologies or protocols described, as these may vary. The terminology used in this description is for the purpose of describing the particular versions or embodiments only and is not intended to limit the scope.

In the various embodiments, systems and methods of the present disclosure relate to authenticating and tracking information associated with physical and/or digital items across various industries. In some embodiments, the systems and methods are configured to ascribe, extract, and/or track value related to events and/or transactions involving the information. The value can be monetary, for example in the form of currency, or intrinsic, for example in the form of positive social impact resulting from good deeds. Furthermore, the present disclosure includes an Artificial Intelligence (“AI”)-, blockchain-, and quantum-enhanced provenance, decentralized authenticity, and/or royalties ecosystem. The systems and methods leverage AI, blockchain, smart contracts, quantum modules, multi-sensor capture, gamified Certificates of Authenticity (“COAs”), and/or expanded identifier frameworks to establish immutable provenance records, to mitigate and/or prevent counterfeiting, and/or automate royalty distribution. In some embodiments, the systems and methods combine real-time live capture, multi-sensor scanning, expanded identifiers, AI fingerprinting, multi-code (e.g., three code) authentication blockchain provenance, quantum-secure processing, and interactive Genesis Certificates of Authenticity (COAs) into a single continuous provenance creation and verification loop.

Applications include, but are not limited to, memorabilia, collectibles, visual arts, music, entertainment, fashion, luxury goods, cultural assets, event-worn apparel, game-used equipment, toys, figurines, clothing/apparel, footwear, couture pieces, jewelry, watches, furniture, handbags, interior design objects, gaming, literature, real estate, pharmaceuticals, medical devices, aerospace, defense, agriculture, energy infrastructure, and government identity systems, as well as specialized embodiments for professional-certified (e.g., CPA-certified) financial reports, employment royalties, biometric name/image/likeness (“NIL”) authentication with lifetime royalty streams, Asset backed Securities, non-profit donations and service hours with tax-linked royalties, and/or inheritance/insurance claim verification for high-value assets.

Referring to the figures, an authentication and tracking system comprises a computer system employing artificial intelligence, blockchain technology, and smart contracts to authenticate, track and enhance legal awareness of items across various industries; for example, memorabilia, art, music, entertainment, real estate, fashion, luxury goods. The authentication and tracking system includes a smartphone application. The smartphone application includes a simple and intuitive user interface, guiding users through each step of an authentication and tracking method with prompts and real-time assistance.

The authentication and tracking system utilizes artificial intelligence (AI) authentication methods; blockchain-based provenance, and ownership tracking; comprehensive tracking systems; enhanced legal and awareness measures; and addresses inauthentic and non-trackable items to standardize royalty tracking, strengthen provenance and ownership verification, and combat counterfeiting and fraud across diverse sectors.

An authentication and tracking method includes the steps of: creating, by an originator (e.g., athlete, artist, author, or the like), the item (e.g., memorabilia); creating an authentication record for the item; authenticating the item; selling the item and recording sale; and sending royalty payment to originator.

In some embodiments, the originator may autograph the memorabilia. This autograph triggers the creation of an authentication record in a public record ecosystem (blockchain or another distributed ledger). This record includes a unique identifier for the memorabilia, details about the autograph, and its initial owner (a first collector).

In some embodiments, a certificate of authenticity may be rendered. The process for this may include the steps of video recording of signing and origin verification; AI-powered scanning for authentication and provenance; uploading the recorded video and integrating data; creating a multi-dimensional, for example a three-dimensional (3D), certificate of authenticity (COA); and integrating AI smart contract and blockchain.

In some embodiments, subsequent to creating the COA, a first owner acquires the autographed item. This transaction is recorded on the blockchain in the authentication and tracking system, establishing provenance and authenticity of the item; and the COA is transferred or issued to the first owner.

In some embodiments, if the item is purchased from a second owner, the royalties are initiated and sent to the originator via the authentication and tracking system. A smart contract associated with the item automatically calculates and transfers a predefined royalty percentage from the sale price to the originator. In alternative embodiments, if the item is given to the first owner via live autograph, then royalties are not initiated. In this case, the royalties are triggered once the purchase is made from the first owner but not from the originator.

In some embodiments. as the item is resold to various owners, the transaction is always authenticated and recorded on the blockchain, updating the ownership details an ensuring continued tracking of the item's provenance, the COA is transferred to the new owner and the smart contract executes, transferring the royalty payment to the originator.

In some embodiments, owners can become a member of a perks and rewards club, for example titled “The Legacy Circle: Perks and Rewards Ecosystem,” associated with the authentication and tracking system. The perks and rewards club may include an ecosystem for item owners, becoming part of originator's legacy, with access to, amongst other things, exclusive content and events, ownership recognition, unique experiences, community and networking.

Shown throughout the figures, the present invention is directed toward an authentication and tracking system and method. The authentication and tracking system provides an integrated solution to address the key issues of standardization, tracking, and authentication across memorabilia, art, music, entertainment, real estate, fashion, luxury goods, software, and digital products. By combining artificial intelligence-powered authentication, blockchain-based provenance, and smart contracts, the authentication and tracking system ensures reliable royalty payments, combats counterfeiting, and provides clear, verifiable records. This approach enhances the protection of originators'rights and builds trust and value in the market for collectors, buyers, and users.

The authentication and tracking method performed by the authentication and tracking system enables originators and athletes to benefit from a secure and efficient system that ensures they receive fair compensation for their contributions, while collectors and buyers gain confidence in the authenticity, tracking and value of the memorabilia they purchase.

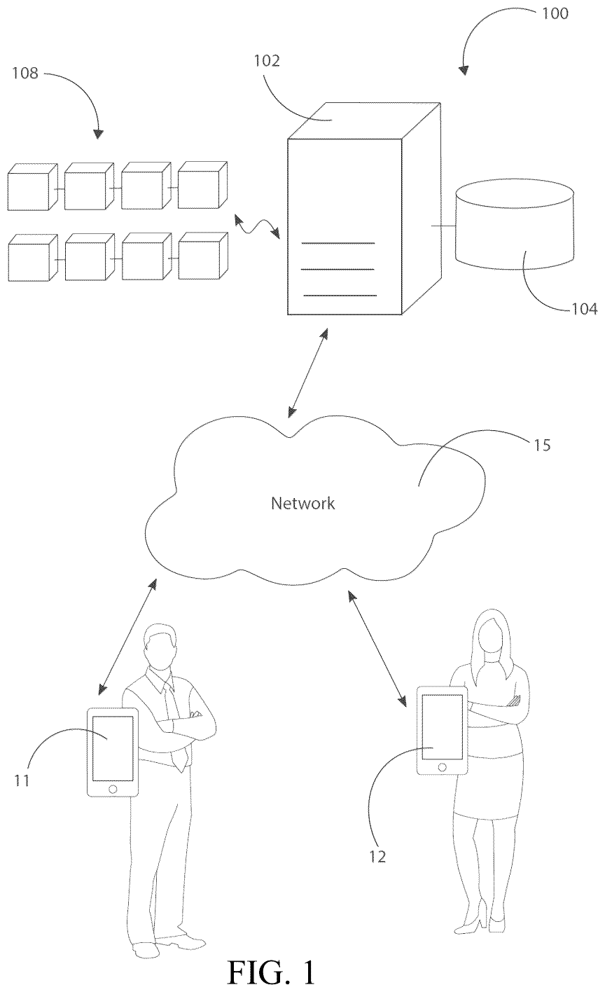

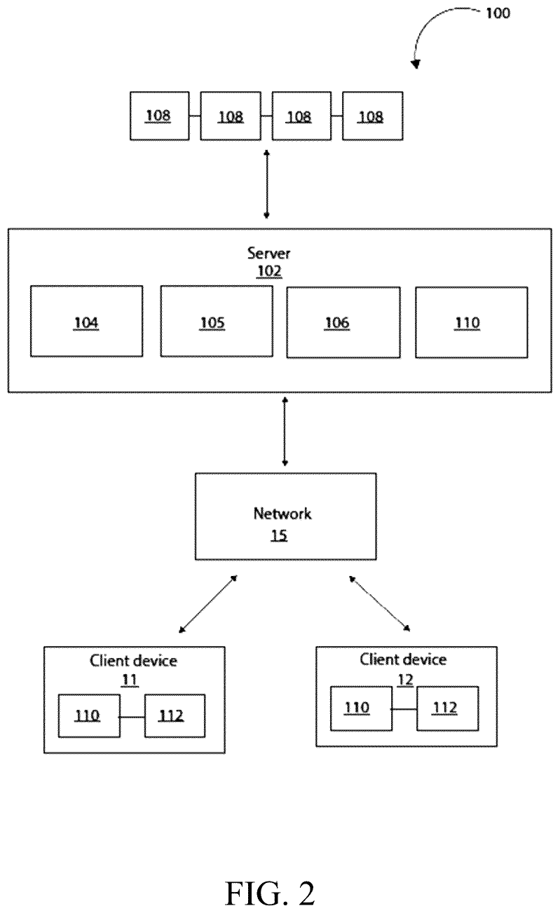

Referring to FIGS. 1-2, illustrating schematic diagrams of an authentication and tracking system 100, according to one or more embodiments of the present disclosure. As shown in FIG. 1, an example environment for the authentication and tracking system 100 includes one or more servers 102 having a database 104 and one or more processors 105 for performing the authentication and tracking method 200, as will be discussed in more detail below. The authentication and tracking system 100 employs artificial intelligence 106, blockchain technology 108 and API's 110 to authenticate, track and enhance legal awareness of items across various industries.

Further, in some embodiments, the authentication and tracking system 100 may include a smartphone application 112 useable on a client device (an originator client device 11 and one or more collector client devices 12) and configured to communicate with the one or more servers 102 over a network 15 (for example, the Internet). The smartphone application 112 includes a simple and intuitive user interface, guiding users through each step of an authentication and tracking method 200 with prompts and real-time assistance.

The authentication and tracking system 100 utilizes artificial intelligence (AI) authentication methods; blockchain-based provenance and ownership tracking; comprehensive tracking systems; enhanced legal and awareness measures; and addresses inauthentic and non-trackable items to standardize royalty tracking, strengthen provenance and ownership verification, and combat counterfeiting and fraud across diverse sectors.

In some embodiments, the AI-powered authentication methods may be utilized for signature recognition. In particular, the AI may analyze and verify signatures and inscriptions across various items, from memorabilia to digital products, comparing them to a database 104 of verified examples. Further, the AI-powered authentication methods may be utilized for visual recognition. In particular, the AI examines visual elements, such as unique features and styles, ensuring the authenticity of memorabilia, artwork, fashion items, and digital assets. In addition to this, the AI-powered authentication methods may be utilized for forensic analysis. For example, the AI may be utilized in ink and paper analysis for physical items and code verification for software, to confirm their authenticity.

The blockchain-based provenance and ownership tracking may be utilized in creating an immutable ledger. In particular, the blockchain may be implemented to create an unchangeable digital ledger documenting ownership and provenance for all types of assets, ensuring a transparent history. Further, the blockchain-based provenance and ownership tracking may be utilized in tokenization. In particular, to tokenize physical and digital items as unique assets on the blockchain, linking digital records to tangible goods and providing secure verification. In addition to this, the blockchain-based provenance and ownership tracking may be utilized in smart contracts. In particular, smart contracts can be used to automate royalty payments, triggered by transactions to ensure originators receive their due compensation automatically based on predefined conditions.

The comprehensive tracking systems may include a unified platform integrating the AI, blockchain, and smart contracts for real-time tracking of assets across multiple markets and platforms. The integrated API's 110 are created for seamless connectivity with various resale platforms and databases, ensuring comprehensive and updated records of transactions and ownership changes. Further, AI may be leveraged for real-time analytics on ownership changes, transaction history and royalty payments to detect discrepancies and prevent fraud.

The enhanced legal and awareness measures may include legal framework. In particular, legal experts may collaborate with the authentication and tracking system 100 to establish standardized agreements and frameworks that support automated royalty enforcement and rights protection through smart contracts. The authentication and tracking system 100 may integrate with legal platforms to protect the rights of the originator and owner, ensuring compliance with intellectual property laws and regulations.

In some embodiments, the enhanced legal and awareness may include educational programs. In particular, the authentication and tracking system 100 may implement educational programs to inform originators about their rights and the new system, providing resources to help them effectively use the technology.

The addressing of inauthentic and non-trackable items may include AI-driven counterfeit detection. In particular, AI tools may detect and flag counterfeit items by analyzing inconsistencies in signatures, visual elements, or other characteristics. Further, the authentication and tracking system 100 maintains detailed provenance records on the blockchain 108, ensuring each item's history is documented and verifiable. In addition, the authentication and tracking system 100 may ensure transparent tracking through blockchain 108, allowing easy verification of an item's history and authenticity.

In addition to the authentication and tracking features of the authentication and tracking system 100, the authentication and tracking system 100 is designed to authenticate, track and manage the sale of items, such as collectibles, memorabilia, art, music, real estate, cannabis and more. Integrating artificial intelligence 106 with blockchain technology 108 and smart contracts, the platform ensures authenticity, provenance, and continuous monetization of assets throughout their lifecycle.

Features of the authentication and tracking system 100 may include AI-powered authentication; blockchain-based tracking and recording; smart contracts for automated royalties; seamless sale and resale process; cross-industry application; continuous tracking and provenance; user-friendly interface; security and privacy; and AI-powered valuation and analytics.

The AI-powered authentication includes autograph and signature verification, digital asset verification, cannabis product authentication and real estate authentication. In particular, AI algorithms analyze and verify autographs, artist signatures, objects, materials, and other unique identifiers for items like memorabilia, collectibles, fashion, luxury goods, art and music. For digital assets like music files or NFTs, AI cross-references metadata, digital signatures, and other characteristics to authenticate and verify ownership. For cannabis, AI can verify strain authenticity, quality certifications, and producer credentials, ensuring that the products meet regulatory standards. For real estate, AI verifies documents, ownership records, and property history to ensure the authenticity and legitimacy of real estate assets.

The blockchain-based tracking and recording includes public record ecosystem and immutable transaction history. In particular, each authenticated item is recorded in a decentralized public ledger (e.g., blockchain 108), creating a tamper-proof, transparent record of ownership and provenance. All transactions, including sales, transfers, and royalty payments, are permanently recorded on the blockchain, ensuring that the entire history of the item is accessible and verifiable.

Smart contracts for automated royalties includes royalty calculation and distribution; and customizable terms. In particular, smart contracts automatically calculate and distribute royalty payments to an originator of the item, every time the item is sold. This ensures that the originator, whether an author, originator, composer, influencer, innovator, performer, designer, visionary, athlete, artists, cannabis grower, or real estate developer, benefits financially from each transaction, creating a continuous revenue stream. Originators can set custom royalty percentages and terms for their creations, ensuring flexibility in how they monetize their work.

The seamless sale and resale process includes initial sale and ownership transfer, subsequent sales and real estate transactions. In particular, when a first collector acquires the item from the originator, the transaction is authenticated and recorded on the blockchain, establishing the item's provenance. Each resale triggers the AI to authenticate the transaction, update the blockchain with the new ownership details, and execute the smart contract for royalty payment to originator. For real estate, the smartphone application 112 handles title transfers, lien checks, and ensures that all legal requirements are met, with each step recorded on the blockchain.

With memorabilia, art and sports items, the authentication and tracking system 100 is able to authenticate autographs, artwork, and sports memorabilia, track their provenance and ensuring that originators like athletes receive royalties from each sale. With music and digital assets, the tracks the ownership and sale of music files, NFTs, and other digital assets, ensuring that creators are compensated for their work authentication and tracking system 100. In the cannabis industry, the authentication and tracking system 100 ensures that cannabis growers and producers can authenticate their products, track them through the supply chain, and receive royalties or certification fees from each sale. In real estate, the authentication and tracking system 100 manages the authentication, sale, and transfer of property, with AI verifying documents and ownership history, while smart contracts handle payments and transfers.

The authentication and tracking system 100 provides real-time updates on the status of authenticated items, including ownership changes and royalty payments. Further, users can generate detailed reports that show the complete history of an item, including all transactions, ownership transfers, and associated royalties.

The user-friendly interface of the authentication and tracking system 100 includes a centralized dashboard, which provides users with an overview of their assets, including authentication status, transaction history, and potential market value; marketplace integration where users can buy, sell, and transfer authenticated items directly within the app's marketplace, with all transactions recorded on the blockchain; and the user friendly smartphone application 112 as discussed above. All data, including authentication records, transaction details, and personal information, is protected by end-to-end encryption. Further, users have complete control over their data, with options to anonymize transactions or restrict access to certain information.

The authentication and tracking system 100 enables analysis of market trends and historical data via AI to provide users with insights into the potential value of their collectibles, art, cannabis products, or real estate; and offers predictions, via AI, on future market conditions, helping users make informed decisions about when to buy, sell, or hold their assets.

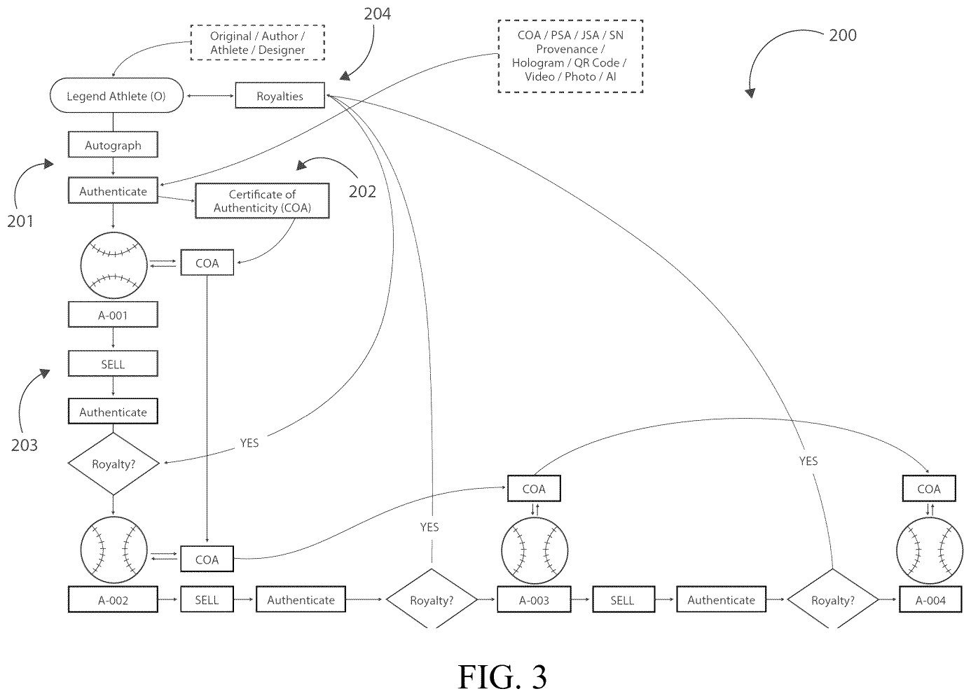

Referring to FIG. 3, an example flow diagram illustrates one embodiment of an authentication and tracking method 200, according to one or more embodiments of the present disclosure. The authentication and tracking method 200 is a process leveraging AI and blockchain to create a robust, transparent, and automated system that ensures the originator continually benefits from their work, while also maintaining the integrity and value of the authenticated item (e.g., memorabilia).

Generally, the authentication and tracking method 200 includes the steps of: step one 201, creating, by an originator (e.g., athlete, artist, author, or the like), the item (e.g., memorabilia) and, by an authentication and tracking system 100, creating an authentication record for the item; step two 202, authenticating, by the an authentication and tracking system 100, the item; step three 203, selling the item and recording, by the authentication and tracking system 100, the sale; and step four 204, sending, by the authentication and tracking system 100, royalty payment to the originator.

In step one 201 of the authentication and tracking method 200, the originator (denoted by the letter “O”) may autograph the item. This autograph triggers the creation of an authentication record in a public record ecosystem (blockchain or another distributed ledger).

This record includes a unique identifier for the memorabilia, details about the autograph, and its initial owner (a first collector).

In step two 202 of the authentication and tracking method 200, a certificate of authenticity may be rendered. The process for this may include the steps of: step one, video recording of signing and origin verification; step two, AI-powered scanning for authentication and provenance; step three, uploading the recorded video and integrating data; step four, creating 3D certificate of authenticity (COA); and step five, integrating AI smart contract and blockchain.

The video recording of signing and origin verification captures the moment of creation or authentication by the originator to establish a digital record. To do this, the originator may utilize a smartphone or designated device to record a video of themselves signing or creating the item (e.g., memorabilia, art, collectible, or the like). The video includes metadata such as geolocation, timestamp, and unique identifiers (e.g., serial numbers, QR codes) associated with the item. AI facial recognition and voice authentication can be implemented to verify the identity of the originator during the recording; and the recording is encrypted and stored securely in a cloud database 104, linked to the item's unique identifier, on the authentication and tracking system 100.

The AI-powered scanning for authentication and provenance analyzes the physical attributes of the item for authentication and establish its provenance. This process may include a user (e.g., owner, buyer, verifier, or the like) using a smartphone application 112 of the authentication and tracking system 100 to scan the item, capturing high-resolution images or 3D scan of its physical features, such as materials, autographs, serial numbers and other distinguishing marks. AI algorithms analyze the scanned data, comparing it against the original video and known reference models (e.g., signatures, materials, manufacturing details) stored in a centralized or distributed database 104 in the authentication and tracking system 100.

The authentication and tracking system 100 checks for consistency between the scanned item and the original metadata (timestamp, location, etc.) to ensure authenticity and trace provenance. The smartphone application 112 provides real-time feedback, highlighting any discrepancies or confirming authenticity.

There are several authentication methods contemplated for use in authenticating items in the authentication and tracking system 100. For example, Certificate of Authenticity (COA), professional authentic services, provenance (i.e., documentation or evidence that traces the history of the item), comparison analysis, holograms, serial numbers and QR codes applied to the item, expert appraisal, technological analysis, photographic and video evidence, and artificial intelligence 106.

The uploading the recorded video and integrating data includes combining the original video recording with the scan data to complete the authentication process. In particular, one the AI has verified the item's authenticity, the user uploads the video recording from step one (video recording of signing and origin verification) to the platform on the authentication and tracking system 100. The platform automatically links the video with the scan data, creating a comprehensive digital profile for the item. This profile includes all relevant metadata (e.g., timestamps, location, item characteristics), ensuring a complete and verified provenance history.

The creating 3D certificate of authenticity (COA) provides a visually appealing and tamper-proof digital certificate that certifies the item's authenticity. In this process, the platform on the authentication and tracking system 100 generates a 3D virtual COA based on the verified data from steps one, two and three above. The originator or authorized party can customize the design of the COA, adding elements like holographic seals, personalized messages, or digital signatures. The COA includes an embedded link to the video recording and a scannable QR code that directs to the item's full digital profile. The 3D COA is stored on the platform and is accessible via the smartphone app or a secure web portal.

Integrating AI smart contract and blockchain ensures permanent and transparent tracking of ownership and provenance through blockchain technology 108. After the COA is finalized, an AI system on the authentication and tracking system 100 generates a smart contract that includes all relevant details: item description, originator identity, transaction history, and ownership conditions.

The smart contract is automatically deployed on a blockchain, ensuring immutable and transparent records. Blockchain fees are calculated and applied, and the transaction is completed. The smart contract also facilitates future ownership transfers, ensuring ongoing provenance tracking and royalty payments (if applicable). Users can access the blockchain record through the smartphone application 112, allowing for easy verification and transfer of ownership. AI continuously monitors for any alterations or counterfeiting attempts, with alerts sent to the owner and the originator.

Key features of the 3D COA may include AI powered scanning authentication and provenance (to analyze the physical attributes of the item for authentication and establish its provenance); video integration (as each 3D COA comes with embedded live video of the originator signing or creating the item, which serves as proof of authenticity and also creates a personal connection for the collector); customizable 3D design (allowing the originator to incorporate their signature elements, colors, branding, etc. and make the COA a digital masterpiece that compliments the item is authenticates); interactive experience (the COA is fully interactive, allowing users to explore every detail of the COA, bringing it to life and transforming it into a dynamic piece of digital art in its own right); blockchain-enabled security (as each COA is stored on a blockchain, guaranteeing that the COA cannot be tampered with); smart contract integration (automating royalty payments and other legal agreements, ensuring compensation to the originator and maintaining integrity of their rights); Augmented Reality (AR) & Virtual Reality (VR) compatibility (collectors can view the COA in AR and VR, providing an immersive experience); and global accessibility (as the COA is accessible anywhere in the world).

In step three 203 of the authentication and tracking method 200, subsequent to creating the COA, a first owner (or ‘collector’) acquires the autographed item. This transaction is recorded on the blockchain in the authentication and tracking system 100, establishing provenance and authenticity of the item; and the COA is transferred or issued to the first owner.

In step four 204 of the authentication and tracking method 200, if the item is purchased from a second owner, the royalties are initiated and sent to the originator via the authentication and tracking system 100. The smart contract associated with the item automatically calculates and transfers a predefined royalty percentage from the sale price to the originator. On the other hand, if the item is given to the first owner via live autograph, then royalties are not initiated. The royalties are only activated once the purchase is made from the first owner (not from the originator).

As the item is resold to various owners, the transaction is always authenticated and recorded on the blockchain, updating the ownership details an ensuring continued tracking of the item's provenance, the COA is transferred to the new owner and the smart contract executes, transferring the royalty payment to the originator. The smart contract is able to be updated or amended to adapt to new market conditions, legal requirements, or originators evolving preferences, ensuring that the royalties process remains effective and relevant.

The authentication and tracking system 100 dynamically calculates royalty payments for each sale, adjusting for sale price and other conditions predefined by the originator. This guarantees that the originator receives royalties from every transaction, creating a continuous and sustainable revenue stream; and ensures that the item's provenance remains intact with ongoing authentication and recording, thereby enhancing the value and authenticity of the item over time.

The authentication and tracking system 100 allows for advanced royalty management. In particular, the smart contract can be programmed to include compound royalty structures, where the originator earns a percentage of the royalty from previous transactions in addition to the current sale - incentivizing long-term value growth; tiered royalty rates, where the originator can define tiered royalty rates, where the royalty percentage increases or decreases based on factors like the number of resales, the time elapsed since the initial sale, or the total accumulated value of sales; and royalty sharing, where the originator can choose to share a portion of the royalty with other stakeholders (e.g., co-creators, agents, or charities), with the smart contract automatically distributing the funds accordingly.

Further, the authentication and tracking system 100 allows for market insights and analytics. In particular, the originator is able to access, via the authentication and tracking system 100, AI-powered analytics that provide insights into market trends, resale value predictions, and royalty earnings forecasts. Further, the originator is able to monitor royalty payments, transaction history and item's market performance in real-time through a dedicated dashboard.

The authentication and tracking system 100 is designed to be interoperable with other platforms and ecosystems, allowing the originator to benefit from royalties across different marketplaces and decentralized ecosystems.

There are several tracking methods contemplated for use in tracking items in the authentication and tracking system 100. For example, RFID tags may be attached to items to allow physical tracking via RFID readers; barcodes or QR codes may be attached to items to allow physical tracking via readers and scanners; GPS trackers can provide real-time location tracking; Digital Asset Management (DAM) systems can be used to catalog, tag and track digital files such as photos, videos and documents; inventory management software can track location, status and details of each item; NFC tags can be embedded or attached to items to allow for near field communication tracking; blockchain-based tracking platforms create secure immutable records of ownership; and IoT sensors can track environmental conditions, movement and location of physical items.

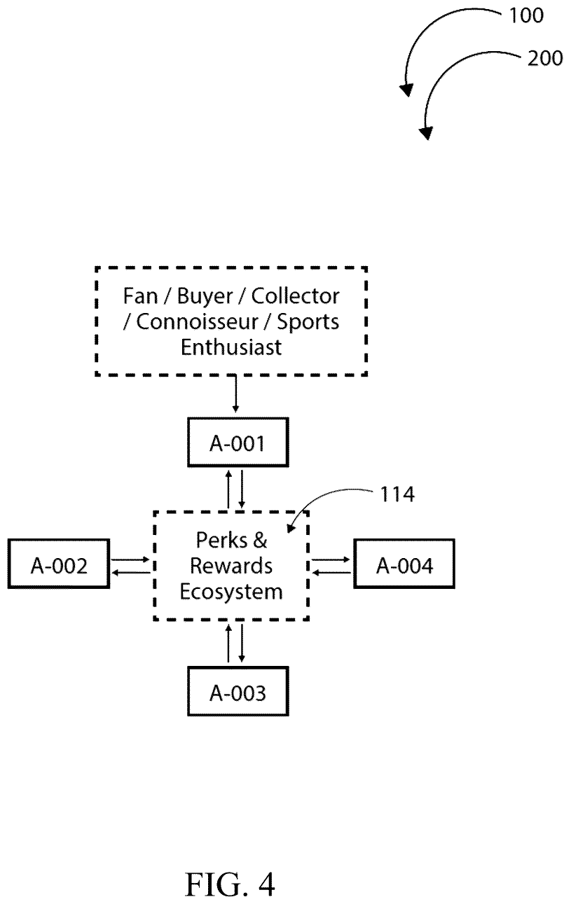

Referring to FIG. 4, an example flow diagram illustrates various owners becoming members of a perks and rewards club 114. Each owner from a subsequent sale of the item may join the perks and rewards club 114, titled “The Legacy Circle: Perks and Rewards Ecosystem”, and associated with the authentication and tracking system 100. For example, the first collector (denoted by A-001) may become a part of the Legacy Circle upon purchase of the item from the originator; a second collector (denoted by A-002) may become a part of the Legacy Circle upon purchase of the item from the first collector; a third collector (denoted by A-003) may become a part of the Legacy Circle upon purchase of the item from the second collector; a fourth collector (denoted by A-004) may become a part of the Legacy Circle upon purchase of the item from the third collector; and so on.

The Legacy Circle includes an ecosystem for item owners, becoming part of originator's legacy, with access to, VIP access and exclusive events; ownership recognition and personalization; exclusive content; profit sharing; unique experiences and interactions; community and networking opportunities; philanthropy and social impact; and legacy and heritage.

In particular, VIP access and exclusive events offer fans and collectors a chance to experience behind-the-scenes moments that are usually off-limits. Whether it's a virtual or in-person look at the creation process, like a studio session, design workshop, art exhibit setup, or a training session with a sports athlete, these experiences provide unique insight. Private meet-and-greets allow for virtual Q&A sessions, autograph signings, or one-on-one encounters with favorite sports stars or artists. Additionally, fans can receive invitations to events such as movie premieres, album release parties, art gallery openings, sports events, or fashion shows. Exclusive event tickets are another perk, offering early or discounted access to concerts, festivals, performances, and major sports events. In addition, VIP tours provide private access to creators'studios, museums, training facilities, or design ateliers.

Ownership recognition and personalization create a deeper bond between creators and their supporters. A digital ownership badge allows fans to display their ownership on social media or personal profiles. Personalized creator messages, whether in video or audio format, offer a direct connection with a creator, artist, or athlete, expressing gratitude for the support. Further, a one of a kind piece of art, designs, or sports memorabilia personalized by the creator; and a special certificate of authenticity, signed by the artist, athlete, or creator, acts as a commemorative piece, acknowledging the fan's ownership and support.

Exclusive content and limited editions provide fans with early access to special releases, such as limited-edition merchandise, artwork, sports memorabilia, or NFTs, all available to a select group before reaching the public market. Fans also get to enjoy unreleased music tracks, videos, design sketches, or sports highlights (e.g., highlight reels), which are only available to members. In addition, limited-edition collectibles, whether physical or digital are available to members of the Legacy Circle.

Profit sharing gives fans and collectors a direct stake in the success of the creators they support. Through revenue-sharing models, members can participate in profit-sharing models where a portion of sales from new releases is distributed among select members.

Unique experiences and interactions further elevate the fan experience. Live sessions allow fans to engage directly with creators, artists, or athletes during their creative or training processes, offering feedback and suggestions in real time. Immersive AR/VR experiences bring fans even closer to their collectibles, art, or sports memorabilia, offering virtual reality tours or augmented reality views. Creative collaborations give members the chance to co-create a piece of art, design, or content, or even work alongside a creator. Further, some NFTs unlock special experiences or interactions with creators, offering custom shoutouts, personalized content, or exclusive sports experiences.

Community and networking opportunities include joining private online communities or social media groups where members can connect with other like-minded collectors, fans, or sports enthusiasts. Members can also participate in members-only auctions or trades where they can exchange collectibles, sports memorabilia, or art with other enthusiasts. Mentorship opportunities allow them to engage in mentoring sessions where creators, artists, or athletes share their knowledge and expertise with members. Additionally, members can attend exclusive networking events where they can meet other collectors, creators, athletes, and industry insiders.

Philanthropy and social impact involve supporting philanthropic initiatives by purchasing special edition collectibles or sports memorabilia, with proceeds going to charity. Members can participate in projects that give back to communities, with contributions recognized by creators or athletes. Eco-friendly perks may include receiving eco-conscious rewards, such as limited-edition sustainable items or carbon-offset certificates tied to a member's collectible.

Legacy and heritage opportunities allow members to be part of the legacy by having their name or contribution recognized in a creator's heritage project, such as a documentary, biography, sports hall of fame, or museum exhibit. Members may also get your collectible, artwork, or sports memorabilia included in a digital or physical time capsule created by the creator or athlete. Further, members can transfer their membership and its perks to a chosen heir, ensuring that their legacy continues for future generations.

An alternative embodiment of the tracking and authentication system 100 is provided in the form of a tracking and authentication system 300. The tracking and authentication system 300 is similar to the tracking and authentication system 100 with the following exceptions. The tracking and authentication system 300 includes Quantum Processing Modules, Multi-Sensor Capture, Virtual Interactive Genesis COAs, Expanded Identifier Frameworks, and Detailed End-to-End Provenance Flow. The Quantum Processing Modules allow for anomaly detection, pattern matching, and quantum-resistant cryptography. The Multi-Sensor Capture includes simultaneous expanded identifiers. The Virtual Interactive Genesis COAs includes multi-dimensional, for example a three-dimensional and/or four-dimensional (3D/4D), gamified, AR/VR-compatible variants. The Expanded Identifier Frameworks ensures layered authentication security. The Detailed End-to-End Provenance Flow include Steps 0-9, as described below. The quantum processing modules, gamified Genesis COAs, and expanded identifier frameworks extend both technical capabilities and provide compliance coverage.

In some embodiments, an originator or owner initiates authentication using a smartphone, scanning device, AR glasses, or VR headset. The process can include Continuous live capture with embedded timestamp, GPS, and device ID. Identity verification can then be implemented, for example by using face recognition, voice/verbal confirmation, and liveness detection. In some embodiments, Multi-sensor scanning such as visual, ultrasonic, RF/NFC, thermal, DNA/chemical, and/or other biometric or spectral signals is also utilized. Simultaneous expanded identifiers can be captured, such as QR codes, serial/minted numbers, holograms, DNA taggants, UV/IR markers, microprinting, laser etching, biometric material signatures, and other physical/digital identifiers. Three-code application and verification can be implemented before fingerprint hashing, which can serve as a tamper-deterrent. AI Fingerprint Hash can then be generated by fusing all identifiers and sensor data into a high-entropy reference, mapped to a TokenID and stored on a blockchain ledger. Then, Quantum module integration can be used for accelerated pattern matching, anomaly detection, photo-event correlation, and quantum-resistant cryptography. COA Issuance Logic proceeds next. If no prior COA exists, a Genesis COA is generated. Alternatively, if a COA exists, it is verified. COA mismatches are flagged. Genesis COA Creation (e.g., Interactive & Gamified) is then initiated, which can include a multimedia video and 3D/4D artifact accessible on mobile, desktop, AR/VR, with Proof-of-Origin video, resale lineage, valuation history, royalty terms, and unlockable gamified content (e.g., AR replays, behind-the-scenes access, Legacy Circle membership). Smart contract activation can embed automated royalty structures and execute upon resale or transfer events. Ongoing verification and royalties occurs at each resale via blockchain ledger matching and re-scanning. This system provides a tamper-proof, immersive, and/or monetized authentication ecosystem across industries such as memorabilia, collectibles, art, fashion, luxury goods, music, entertainment, gaming, real estate, and high-value supply chains. The foregoing is one example of how the sequence can progress. In alternative embodiments, another suitable order of steps in the process may be used.

When no prior COA exists, the system 100, 300 can issue a Genesis COA. The Genesis COA is unlike traditional (e.g., paper) certificates. In some embodiments, the Genesis COA can be Multimedia-based, for example comprising a Video+3D/4D artifact. The genesis COA can be Cross-platform. For example, the Genesis COA can be Mobile, desktop, AR/VR accessible. The Genesis COA can provide Proof-of-Origin, such as embedded live capture with geo location/time/date of the event. The genesis COA includes Expanded Metadata, for example venue data, device logs, spectral signatures. The genesis COA can include Ownership Lineage that tracks all transfers and resales. The genesis COA also can include Valuation Data, such as market pricing and appraisal history. In some embodiments, the genesis COA also includes Royalty Integration: Embedded payout logic for creators.

In alternative embodiments, the Genesis COA can be gamified by including a gamification layer. The gamification layer provides an interactive user experience. For example, the gamification layer can include unlockable AR/VR replays and/or behind-the-scenes content. In some embodiments, the gamification layer includes fan leaderboards, leaderboard rankings, and loyalty club (e.g., Legacy Circle) membership. The gamification layer can further include Dynamic COAs that evolve with resales or predetermined milestones.

Each Genesis COA, whether multimedia-based or gamified, remains cryptographically bound to the royalties engine, ensuring that interactive experiences and unlockable content are inseparably tied to automated royalty distribution and resale verification.

In some embodiments, the system 300 can simultaneously Read/Apply Expanded Identifiers. The system 300 can fuse real-time sensor data with expanded identifiers, ensuring a multi-layered provenance matrix. The following is a non-exhaustive listing of exemplary sensor data that can be fused with expanded identifiers: QR Codes, Serial Numbers/Minted Numbers, RFID/NFC Tags, Holograms/Holographic Labels, Tamper-Evident Seals, Digital Watermarks, Blockchain-Based Identifiers, DNA Tagging/Chemical Taggants, Microtext/Microprinting, Smart Labels with Sensors, Optical Variable Ink (OVI), Laser Etching/Engraving, Micro-Engraving, Biometric Material Signatures, Magnetic Stripes/Threads, UV/IR Markers. This identifier fusion can produce the AI Fingerprint Hash. The Ai Fingerprint has a high-entropy, authoritative reference written immutably to blockchain. In some embodiments, this immutable binding directly links the AI Fingerprint Hash to a TokenID record and blockchain provenance ledger, ensuring that expanded identifiers are preserved as part of the permanent authenticity record.

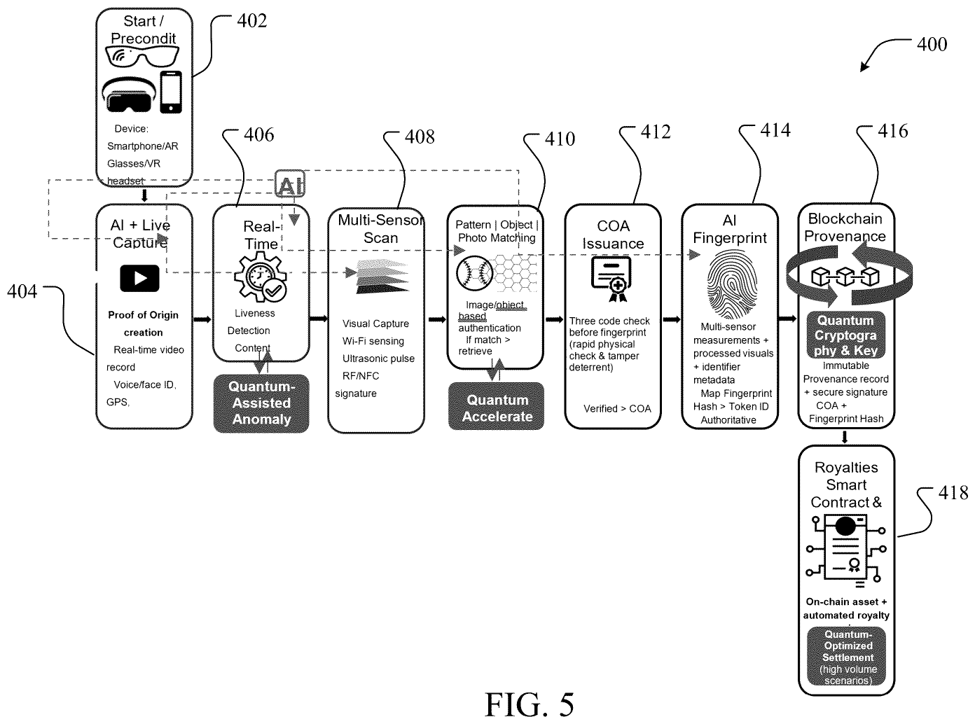

Referring to FIG. 5, in some embodiments, Real-Time Live Capture includes Provenance Creation Flow 400 (i.e., Steps 0-9 below). Steps 402-414 (i.e., 0-6) of this flow can be implemented with the system 100 or the system 300. The provenance creation flow begins at step 402 (i.e., 0): Start/Preconditions. The presence of a device, such as a Smartphone/AR glasses/VR headset (with optional thermal or RF dongles) is verified. A User is established, which can either be an Originator (athlete/artist) or owner/fan. An Application (i.e., App) can establish an authenticated session, online or offline draft mode. At Step 404 (i.e., 1), AI+Live Capture & Verification (i.e., Proof of Origin) commences. This step can include continuous video capture (timestamp+GPS+device ID), Face recognition and/or verbal confirmation, signing/hand-over detection, and/or Creation of Proof-of-Origin record. At Step 406 (i.e., 2), AI Real-Time Verification occurs. This step can include liveness detection, anomaly detection, and/or Quantum-Assisted anomaly analysis. At Step 408 (i.e., 3), Multi-Sensor Scan & Expanded Identifiers are obtained. Step 408 can include high-resolution photo/3D scans, RF/NFC, ultrasonic, thermal, chemical/DNA reads, and/or application/verification of three distinct codes. At Step 410 (i.e., 4), Quantum-Accelerated Pattern & Photo Matching is initiated. Step 410 includes provenance database (“DB”) accelerated search and/or AI+quantum photo-event correlation. At Step 412 (i.e., 5), a COA Issuance Decision Tree (e.g., Three-Code Before Fingerprint) is activated. If prior a COA exists and there is a verified match, then an Existing COA is identified. If no COA is found, then a Genesis COA is issued. If there is mismatch, the instance is flagged as possible counterfeit. At Step 414 (i.e., 6), AI Fingerprint Hash Creation commences. At step 6, multi-sensor data fusion occurs, a high-entropy fingerprint generated, and the data are Mapped to TokenID with tokenURI.

Steps 416-420 (i.e., 7-9) are implemented by the system 300. At step 416 (i.e., 7), Blockchain Provenance+Quantum Cryptography+ISO 20022 & Codex/Index occurs. At step 416, Quantum-resistant key signing/QKD is initiated. Then, an immutable blockchain write occurs, followed by watermarking and checksum storage. In some embodiments, ISO 20022 Integration occurs, whereby provenance, asset transfer, and royalty events are encoded into ISO 20022-compliant message formats. Step 416 can also include a Codex/Index Layer process, whereby GAAP/IFRS accounting codex, IRS tax codex, and/or sector-specific compliance indexes are attached alongside blockchain entries for audit-ready traceability. In some embodiments, step 7 also includes Dual Anchoring, whereby each AI Fingerprint Hash is immutably written to both blockchain and codex-indexed ledgers. At Step 418, Smart Contract Activation+Allocation & Minting commence. At step 418, one or more royalty-enabled smart contracts are deployed. In some embodiments, quantum optimization is possible for payouts. In addition to allocation and minting, the smart contract can trigger a reporting module, generating ISO 20022-compliant messages and codex-indexed ledger entries in parallel. In some embodiments, step 418 incudes a Royalty Allocation Module, whereby the smart contract includes allocation logic to direct royalties into multiple destinations (e.g., creators, investors, reserves, tax-holding wallets). In some embodiments, step 418 includes a Minting Module that Triggers minting of ecosystem coins or tokens directly from authenticated royalty inflows. These coins can be backed by codex-linked royalty reserves and tied to TokenID lineage. In some embodiments, step 418 further includes Quantum Optimization that ensures payout distribution and minting transactions are optimized for speed/security by using QKD/quantum-resistant signing. At Step 420, Ongoing Verification/Resales+Reporting occurs. At step 420 (i.e., 9, not shown), item(s) are re-scanned and matched. A resale event triggers royalty distribution. In some embodiments, step 420 incudes Continuous Re-Scan & Match, whereby provenance validation is maintained with multi-sensor rescans. In some embodiments, step 420 includes Royalty Distribution & Reserve Tracking, whereby an allocation engine automatically pools royalties into reserves and distributes to recipients. In some embodiments, step 420 includes a Reporting Module that can emit ISO 20022 audit and settlement messages, post GAAP/IRS codex entries for financial/tax compliance, and/or generate CPA-certified reports and/or real-time dashboards for regulators, boards, and investors. Reports generated can include CPA-certified financial statements and regulator-facing dashboards, thereby ensuring audit-ready compliance at each resale or verification event.

The process, i.e., Steps 402-420 (i.e., 0-9), is depicted in FIG. 5. Relationships between the steps and possible pathways are also shown in FIG. 5.

In some embodiments, the authentication and tracking system 100, 300 includes a multi-sensor authentication (e.g., scan) and expanded identifier capture framework (i.e., layer). In these embodiments, artificial intelligence (AI) dynamically directs activation of appropriate sensors based on classification of the subject asset. Classification may include, or example: memorabilia, collectibles, works of art, fashion articles, luxury goods, scrap metals, commodities (physical and digital), real estate, hazardous and non-hazardous liquids, biological samples, mechanical and electrical devices, plastics, metals, air, water, earth, plants, trees, cannabinoids, tobacco, solar materials, oil and gas, energy infrastructure, pharmaceuticals, medical devices, aerospace components, and human biometric features.

Upon classification, the AI module coordinates one or more sensors to capture unique, non-replicable identifiers of the asset. These identifiers may include physical, digital, chemical, biological, and quantum-detectable properties. The multi-sensor authentication layer may include, individually or in combination, any of the following features.

Conventional identifiers such as QR codes; barcodes; serial numbers; minted numbers; holograms; holographic labels; microtext; microprinting; magnetic stripes or threads; tamper-evident seals; digital watermarks; smart labels with embedded sensors; and blockchain-anchored identifiers may be included.

Optical and Electromagnetic Modalities, such as ultraviolet (UV) and infrared (IR) markers; optical variable inks (OVI); laser etching or engraving; optical coherence tomography (OCT); hyperspectral and multispectral imaging; terahertz imaging; Raman spectroscopy; and X-ray or radiographic imaging, may further be included.

Material and Surface Signature Sensors, such as ultrasonic pulse resonance; surface acoustic wave (SAW) sensors; piezoelectric signature sensors; vibrational or phonon sensors; electrochemical analysis; magneto-optical detection; gravimetric sensing; and nanoparticle or quantum dot markers, may also be included.

Thermal and Environmental Modalities, such as thermal imaging; Wi-Fi wave reflection profiles; electromagnetic field (EMF) profiling; radioisotope and radiation detectors; atmospheric and gas sensors (e.g., CO₂, CH₄, VOCs); electrostatic discharge (ESD) profiling; and seismic or vibration sensors, may similarly be included.

Biological and Biometric Identifiers, such as DNA tagging; chemical taggants; microbial or molecular signatures; biochemistry analysis; fingerprint, palmprint, and retina/iris scans; voiceprint biometrics; gait recognition; electroencephalogram (EEG), electrocardiogram (ECG), and electromyography (EMG) bio-signal capture, may be included.

Digital and Cryptographic Identifiers, such as hardware security modules (HSMs); Trusted Platform Modules (TPMs); secure element identifiers (e.g., eSIM, smartcards); cryptographic fingerprint hashing of files or media; and embedded digital certificates, may further be included.

Visual and Motion Analytics, such as continuous video capture; image recognition; photo-matching; motion or action recognition; video anomaly detection; and invisible watermark checks, may also be included.

In operation, the AI system fuses data across these modalities to generate a canonical multi-modal vector signature, resistant to forgery or duplication. This signature is subsequently transformed into a cryptographic AI Fingerprint Hash, optionally reinforced with advanced quantum-accelerated pattern matching and quantum-powered anomaly detection, ensuring both scalability and precision.

In some embodiments, Compliance & Financial Identifiers may also be included. For example, ISO 20022 event tagging, whereby every sensor event generates a financial-grade message for audit and settlement may be included. Codex/index anchoring, whereby identifiers should simultaneously post into GAAP/IFRS accounting codex, IRS/tax codex, and sector-specific indexes (e.g., FDA, DOE, SEC), can also be included. Lifecycle Anchoring, whereby each identifier should include time-stamping, renewal, and archival rules that follow GAAP/IFRS accounting periods and IRS record-retention requirements, can further be included. Cross-Jurisdiction Handling, whereby identifiers must align with cross-border compliance (e.g., GDPR in EU, CCPA in California, CSL in China, HIPAA for medical identifiers, FAA rules for aerospace), may further be included.

An Immutable Audit Trail, whereby each event should generate an append-only blockchain record with dispute-resolution procedures and forensic-grade auditability, can also be included. Error Handling, whereby compliance identifiers should include redundancy and error codes for corrupted, missing, or duplicate entries, can further be included.

In some embodiments, Royalty and Allocation Hooks can also be included. For example, a hook where each multi-sensor identifier capture should link to allocation parameters (e.g., royalty splits, escrow, reserve pools) might be included. A hook where provenance identifiers should serve as minting triggers for non-diluting coins when royalty inflows are confirmed might be included. An Automated Royalty Splits hook where smart contracts should encode dynamic royalty splits (e.g., fixed %, milestone-based, or performance-based) might further be included. An Escrow Enforcement hook where identifiers should auto-trigger escrow releases tied to verified provenance and ISO 20022-compliant settlement messages might also be included. Revocation/Adjustment Protocols can be included to rebalance royalty allocations in real time if identifiers or COAs are revoked. Global Interoperability might be included to ensure royalty hooks should align with international IP frameworks (WIPO standards, copyright societies, and collective management organizations).

In some embodiments Marketplace & Tokenization Identifiers can be included. For example, identifiers should be usable to verify authenticity of assets listed on a marketplace and issued tokens/coins themselves (i.e., so the coin is as authenticated as the asset). This check closes the loop in the chain of physical capture, digital asset, token, and the secondary market. Token Standards might be included that support ERC-721/1155, ISO 24165 digital token identifiers, and cross-chain interoperability protocols (e.g., Polkadot, Cosmos IBC). Secondary Market Tracking might be included, such that identifiers should follow the lifecycle of a token across resale markets, embedding verification logic that enforces authenticity at each transfer.

Anti-Fraud Controls might also be included such that each marketplace verification event should integrate anomaly detection (e.g., resale below-cost triggers fraud review). Exchange Integration might be include, whereby identifiers should be queryable by regulated exchanges and DeFi protocols for real-time compliance checks (KYC/AML).

In some embodiments, Governance, Audit & Accountability Identifiers can be included. For example, governmental identifiers such as legislative votes, foreign communications, proxy war financing, treaties, and/or aid flows might be included. Security identifiers such as airport passenger scans, IT/audit logs, and cybersecurity events might be included. Deepfake/media identifiers, such as comparisons between video or audio baselines and manipulated versions can further be included. The foregoing all should have explicit tie-ins so the system can authenticate “events” as well as “objects.” Event Authentication can be included to ensure that, beyond object authentication, identifiers should validate government votes, financial flows, media baselines, and IT/audit logs in real time. Jurisdictional Mapping can be included to ensure that each event identifier encodes metadata for country of origin, applicable statutes, and oversight authority. Multi-Level Oversight can be included, whereby identifiers should enable nested governance layers (municipal, state, federal, international) with audit crosswalks. Forensic Tracing can be included to ensure events should generate immutable hashes for investigative use (e.g., anti-deepfake baselines, whistleblower trails, FOIA-ready logs).

In some embodiments, Device Layer Cross-Reference can be included. For example, this feature can explicitly call out that identifiers can be captured by any device in the Expanded Device Layer (e.g., wearables, drones, IoT, kiosks, medical/lab instruments, voting terminals, hologram projectors, etc.). Standards Alignment might be included to ensure devices use standardized protocols (e.g., MQTT, OPC UA, ISO/IEEE 11073 for medical, ISO 13485 for regulated hardware). Certification & Calibration can be included to ensure field devices pass certification for identifier capture accuracy, with calibration logs stored in the provenance database. Offline/Edge Capture can be included to ensure devices support offline collection with delayed blockchain syncing when network access is restored. Security Hardening can be included o ensure each device implements tamper detection, secure boot, hardware root of trust (TPM/HSM), and cryptographic firmware signing.

In some embodiments, Genesis COA Integration can be included. For example, multi-sensor identifiers can embed directly into Genesis COA artifacts (e.g., 3D/4D, AR/VR, gamified unlockables). COAs thus become a container for both physical identifiers and financial/compliance metadata. Format Standards can be included to ensure identifiers embed into 3D/4D/XR artifact formats (e.g., USDZ, GLTF, WebXR) for compatibility with AR/VR. Dynamic Updates can be included to ensure Genesis COAs allow versioning so that revoked identifiers can be replaced without invalidating prior provenance history. Gamification Layer: Unlockables (e.g., NFT-style) can be included to tie to real-world compliance events (e.g., royalty release, FDA approval, or ISO certification). User Interaction can be include to ensure end users can verify COAs through mobile/AR apps, kiosks, or IoT devices with consistent UI standards.

As discussed above, the Genesis COA is issued when an asset enters the provenance chain for the first time. The Genesis COA can comprise an immersive, multi-layered architecture that differs from conventional COAs and counterfeit flag. In some embodiments, the genesis COA enables “Multi-Sided 3D/4D Visualization.” For example, the Genesis COA can include two panes: pane A and pane B. Pane A can include Live Capture Video, such as embedded high-resolution video of the original capture session (from Step 1). Pane A can further include visual overlays of rolling nonce, session DNA watermark, and/or signer/actor biometrics. Pane B can include Metadata and Provenance data, such as timestamp (e.g., RFC-3161 TSA), GPS/Geostamp (e.g., lat, lon, alt, accuracy ellipse), device ID (e.g., TEE/TPM-attested), asset description and classification (e.g., “Baseball—Signed by J. Doe, 2025 May 4, Houston TX”), Ownership assignment information from originator to first recipient to successive recipients (e.g., user ID, wallet, or legal entity), file format (e.g., MP4+JSON sidecar, WebM+IPFS hash), security checks (e.g., digital signatures, hash validation on replay), Redundancy/storage data (e.g., how much data per COA, compression approach), and/or information about how overlays (e.g., nonce, biometrics, watermark) are validated and prevented from tampering.

The genesis COA allows for immersive Augmented Reality/Virtual Reality (“AR/VR”) access. For example, mobile access (i.e., Ubiquity & Provenance) such as ARKit/ARCore apps, render the Genesis COA in augmented reality. Users can tap-to-rotate, zoom, and inspect provenance layers with embedded metadata. All interactions can be cryptographically logged (e.g., ISO 20022-compliant Codex transaction codes). The genesis COA offers Full Immersion. For example, if using headsets, WebXR and Unity-based viewers render the COA as a secure, 3D holographic object. VR exploration includes voice commands, gesture recognition, and multi-sensor overlays (RF, NFC, thermal, DNA watermark). Each action can be validated with AI+quantum anomaly detection to prevent spoofing or replay. Gamification & Unlockables can allow users to access hidden layers (e.g., provenance trails, creator notes, supply chain checkpoints) by rotating, tapping, or scanning the holographic COA. Unlocking generates a tamper-proof record tied to the user's authenticated identity and wallet, ensuring non-replicability. The genesis COA can further include Minimum FPS/resolution requirements (e.g., 60 fps, 1080p baseline), Authentication flow (e.g., wallet→PQC session token→AR/VR unlock), Offline/low-bandwidth fallback mode (e.g., 2D view if VR/AR unavailable), Security logging for each gesture/command.

Examples of unlockable and gamified content include Athlete's commentary video (possibly unlockable by owner only), 3D replay of signing/hand-over, behind-the-scenes content for artists/musicians.

In some embodiments the Genesis COA can include Educational Modules with Dynamic videos, annotated images, and contextual text overlays can be integrated directly into each provenance layer. Examples include sports content, such as player commentary, training breakdowns, and play-by-play analysis, Art/Collectibles content, such as artist narration, 3D reconstruction of creation process, and restoration history, and/or supply chain content, such as factory walkthroughs, QA/QC video snippets, and ESG certifications. Each educational asset can be bound to the COA with AI-authenticated watermarks and quantum-resistant encryption. Smart Contract Gating can be provided to ensure unlockables are linked to wallet address; enforced by Solidity/Vyper contracts with PQC signatures.

In some embodiments, the COA can also include information about whether unlockables persist across transfers of ownership, how hidden layers are revoked/re-sealed if asset changes owners, time-based unlockables (e.g., seasonal, event-driven), and/or cross-chain/cross-wallet enforcement, which are apposite if sold on another platform.

The COA can also include Embedded Artifact/Object/Asset Description. For example, Micro-Detail Capture can include high-resolution surface scans (optical/ultrasonic) to reveal scratches, wear, grain, and/or tool marks. Imperfections (e.g., nicks, cracks, fading) and perfections (e.g., gloss, finish, polish) can be stored as distinctive features. Autograph analysis (e.g., stroke width, ink absorption, pen pressure inferred from motion/audio sensors) can also be included. Invisible traits, such as UV/IR reflectivity, nanoparticle taggant patterns, Raman/chemical signatures, can also be included. AI Fusion can further be include, whereby details are fused into the canonical multi-modal vector, ensuring that even two visually identical items have unique embedded fingerprints. 3Code+Photo Match Binding can be included, whereby imperfections and micro-details are directly cross-referenced against tri-code verification and global photo-matching (Step 3 and Step 4). One or more of sensor calibration methods and error tolerances, data structure (e.g., JSON schema for artifactDescriptor), verification frequency (how often rescans are required for ongoing validation), and/or cross-linking with existing standards (GS1, supply chain, art registry) cand also be included. As an output example, the “artifactDescriptor” object can be stored in Genesis COA, providing a narrative and technical profile of the object, beyond just identifiers.

In some embodiments, the genesis COA includes Embedded Cryptographic Anchors. For example, Session DNA, whereby Unique high-entropy seed from Step 402 (i.e., 0), can be embedded in the COA. Canonical Vector Hash can be provided and include multi-sensor fusion from Step 404 (i.e., 2). Tri-Code Proof can be provided and include microcontroller verification from step 406 (i.e., 3). Provenance Evidence ca be provided and include event correlation from step 408 (i.e., 4). Blockchain Anchor can be provided, whereby the Genesis COA hash can be written to Ethereum L2 and anchored to L1. One or more of hashing algorithm specs (e.g., SHA3-512, BLAKE3), PQC suite selection (e.g., Kyber, Dilithium, Falcon), and/or rotation/renewal policy (how often anchors or keys are refreshed), redundancy (e.g., multi-chain anchoring beyond Ethereum L2/L1) can also be provided.

In some embodiments, the Genesis COA can include Software/Hardware Models. For example, rendering can be provided to include Unity/Unreal engines for VR/AR; WebGL/WebXR for browser. Storage can be provided to include IPFS/Arweave for video/data shards; blockchain for hash anchors. Access Control can be provided to include wallet-based authentication; PQC-signed session tokens. Multiple devices can be supported, such as Smartphones, AR glasses, VR headsets, holographic projectors. Multiple Operating Systems (“OS”) and versions thereof can be supported (e.g., iOS/Android). Information about hardware requirements (e.g., GPU, AR headset specs), certification path(s) (e.g., FIDO2, TEE attestation, FDA/medical if applied), and/or edge computing vs. cloud rendering implementation can also be provided.

In some embodiments, the genesis COA can include ISO 20022 and/or Codex/Index Integration. In general, issuing the Genesis COA triggers ISO 20022 message generation (i.e., authentication, asset creation, ownership transfer). For example, embedded codex/index entries, such as GAAP/IFRS ledger event, IRS/tax codex event, sector-specific indexes (e.g., medical, energy, securities) can be provided. This ensures the COA is both a provenance artifact and a financial-grade compliance record. Information about Exact ISO 20022 message types used (e.g., auth.001, pacs.008), trigger conditions for codex events (e.g., mint, resale, unlock), cross-border compliance (e.g., GDPR, FATF, Basel III), and/or storage format for dual audit logs (e.g., JSON, XBRL) can also be provided.

In some embodiments, the Genesis COA can include Royalty Allocation Hooks. For example, the Genesis COA can include embedded royalty logic, allocation parameters (e.g., 10% creator, 5% reserve, 2% tax escrow), smart contract templates preloaded into the COA metadata, jurisdictional tax handling (e.g., US 1099/K-1, EU VAT, etc.), escrow wallet structure (e.g., multi-sig, DAO-managed), and/or inheritance/estate handling. Thus, the Genesis COA is not just a certificate, but a programmable revenue instrument.

In some embodiments, the Genesis COA can include a Minting Module Reference. For example, the State that issued the Genesis COA can mint an associated token/coin, cryptographically linked to its TokenID lineage. Token metadata, such as reserve backing, royalty allocation rules, and audit hooks, can also be included. The minted instruments can become asset-backed digital financial instruments. Information about maximum supply, burn/mint rules, how reserve backing (i.e., reserve-backed) is validated (e.g., proof-of-reserve audits), supported token standards (e.g., ERC-721, ERC-1155, ERC-6551), and/or cross-chain bridging or wrapping strategy can also be provided.

In some embodiments, the Genesis COA can include a Reporting Layer. COA interactions (e.g., viewing, unlocking, resale verification) can automatically trigger reporting events. For example, ISO 20022 audit messages, codex-indexed accounting and tax records, dual audit logs (e.g., blockchain+traditional), and/or automated alerts for anomalies/fraud detection can be triggered. Information about frequency of reporting (e.g., real-time, daily batch, monthly), who has access (e.g., owner, regulator, auditor), export formats (e.g., CSV, PDF, XBRL) can also be provided. Furthermore, NLG-based CPA reporting modules for compliance-ready output can be included.

The Genesis COA is a dynamic, interactive, cryptographically sealed artifact. Multi-Layer Integration simultaneously presents live video, biometrics, metadata, and blockchain evidence. Immersive Provenance that can include Gamified AR/VR visualization that provides experiential authenticity. The artifact stack (e.g., video-pane fusion, metadata binding, AR/VR rendering, blockchain anchoring, smart contract unlockables) is unique to the genesis COA. Moreover, the Genesis COA can be compliance-native, such that it is ISO 20022-ready, codex-indexed, tax/audit embedded. Furthermore, the genesis COA can transform provenance certificates into programmable, auditable, financial-grade instruments.

In some embodiments the Genesis COA includes Expanded Device Integration. For example, Genesis COA can be accessed/triggered by the expanded device layer (e.g., wearables, drones, IoT, vehicles, kiosks, medical/lab, government/financial terminals). Each device can generate contextual metadata (e.g., GPS from drone, biometrics from wearable, transaction logs from POS). API definitions for Internet of Things (“IoT”), drones, wearables can also be provided. Information about privacy/data minimization (i.e., what data is NOT logged), synchronization across devices (e.g., time-stamping), and/or failover if device feed is corrupted or spoofed ca also be provided.

In some embodiments, the authentication and tracking system 100, 300 includes an expanded device layer. For example, live capture and multi-sensor authentication may be activated by a wide array of networked devices, extending beyond conventional smartphones, AR glasses, or VR headsets. The system 100, 300 can be designed such that virtually any device equipped with optical, acoustic, biometric, and/or environmental sensors, combined with network connectivity, can serve as an activation point for initiating the AI-driven authentication workflow. In other words, the system 100, 300 supports diverse capture devices to ensure global coverage. Examples of suitable devices include Wearables, such as Smartwatches, fitness trackers, bodycams, smart clothing, contact lenses; Unmanned Systems, such as UAVs/drones for aerial/environmental capture; Robotics, such as Cobots/inspection robots with optical+LiDAR scanners; Industrial instruments, such as spectrometers, borescopes, XRF analyzers; IoT Devices, such as smart home hubs, voice assistants, connected appliances; Gaming/Entertainment devices, such as consoles, NIL-enabled motion tracker; Vehicles:, such as ADAS, telematics modules, lidar/camera arrays; Medical/Lab equipment, such as ultrasound, CT, MRI, DNA sequencers, microscopes,; Surveillance/Smart City equipment, such as public safety cameras, sensor grids, airport/stadium monitors; Financial/Transaction machines, such as ATMs, kiosks, POS systems with biometric inputs, Bank API,

Compatible wearables and Personal Devices can further include smartwatches, fitness trackers, and other wearable electronics configured to capture biometric signals, environmental context, motion, or voice, body-mounted cameras, smart clothing with integrated micro-sensors, and/or future-ready smart contact lenses capable of video and optical capture.

Compatible Industrial and Professional Devices can further include unmanned aerial vehicles (UAVs/drones) for aerial capture of assets, landscapes, or inventories, robotics and collaborative robots (“cobots”) with integrated cameras, lidar, and sensor packs for scanning items in manufacturing or logistics contexts, and/or specialized inspection devices, including borescopes, handheld scanners, or spectrometers, adapted for material or structural authentication.

Compatible Consumer and IoT Devices can further include Smart home hubs, voice assistants, and connected appliances capable of capturing and transmitting data for authentication, game consoles, motion controllers, and immersive entertainment systems incorporating depth sensors, gesture recognition, and/or NIL-tracking modules.

Compatible Vehicles and Mobility Platforms can further include vehicles equipped with advanced driver assistance systems (ADAS), telematics modules, or lidar/camera arrays capable of authenticating drivers, parts, or transported assets, and/or autonomous delivery robots or transport platforms capable of passive scanning and provenance recording during transit.

Compatible Medical and Scientific Devices can further include portable medical imaging equipment (ultrasound, CT, MRI, handheld diagnostics) for biological or device authentication, laboratory instruments such as spectrometers, DNA sequencers, and/or microscopes that generate AI fingerprint data.

Compatible Public and Infrastructure Nodes can further include surveillance cameras and smart-city sensor grids capable of verifying objects, people, or events at transportation hubs, stadiums, or urban spaces, ATMs, kiosks, and/or point-of-sale terminals configured with biometric or multi-sensor input to authenticate financial transactions and digital asset transfers.

Compatible Immersive & Consumer Media can include AR/VR Headsets, such as Hololens, Oculus/Meta, Apple Vision—capture for provenance of holograms, concerts, or virtual stores; Smart Glasses, mart Lenses, and Smart Contact Lenses including AR overlays tied to NIL/memorabilia and holographic projections; and/or Hologram Projectors, such as devices projecting concerts, products, or virtual events requiring provenance authentication.

Compatible Financial & Transactional Systems include Bank API Nodes & Payment Gateways, such as interfaces that consume ISO 20022 messages for direct settlement; POS Terminals & E-commerce Platforms, such as online payment processors and digital wallets; and/or Crypto Custody Devices, such as hardware wallets and institutional custody nodes integrated with your provenance+royalty engine.

Compatible Industrial & Infrastructure includes SCADA/ICS Systems, such as Authentication of industrial control signals, energy infrastructure, or grid assets; Utility Smart Meters & IoT Nodes, such as authentication of energy credits, PPA events, or carbon tracking; and/or Logistics Tracking Devices, such as RFID portals, pallet scanners, port cranes—for supply chain provenance.

Compatible Government & Civic devices include Voting & Legislative Devices, such as E-voting machines, digital ballot boxes, legislative roll-call systems tied to provenance and audit trails; Public Information Terminals, such as library systems, government kiosks, DMVs, airports; and/or Identity & Border Systems, such as Passport scanners, eID readers, TSA/airport biometric gates.

Compatible Medical & Pharma devices include implantable Devices & Wearable MedTech, such as Pacemakers, insulin pumps, brain-computer interfaces, etc.; and/or Pharma Packaging Scanners, such as authentication of pill bottles, vaccine vials, DNA-tagged meds.

Compatible Defense & Aerospace devices include Military Sensors, such as Radar, sonar, satellite imaging for provenance of defense events; Drones/UAV Swarms such as defense platforms; and/or Spacecraft & Launch Systems, such as authenticating satellite components, launch telemetry.

Compatible Entertainment & NIL devices include Athlete NIL Trackers; such as Motion sensors, biometric wristbands, or live game capture tied to NIL contracts; Smart Ticketing Devices, such as NFC-enabled event tickets, stadium access devices, gamified COAs; and/or VR/Metaverse Platforms: Provenance of avatars, skins, digital goods, tokenized experiences.

Compatible Specialized Authentication Node devices include Quantum Terminals, such as Devices used for QKD key exchange or quantum anomaly capture; RFID/Passive Tags: Asset-level authentication for commodities (e.g., steel, hemp, water barrels, graphene sheets); and/or Embedded IoT Sensors: Chips inside vehicles, appliances, or packaging that auto-authenticate.

The expanded device layer ensures that authentication is device-agnostic and future-proof, enabling the system to be activated from virtually any wearable, industrial, consumer, vehicular, medical, or infrastructural capture point. By embedding the activation logic within AI-driven orchestration and binding results to blockchain provenance with quantum-secure modules, the invention extends protection across both current and emerging ecosystems. The expanded device layer ensures device-agnostic activation of the authentication ecosystem, meaning the system is not limited to smartphones or conventional sensors but is instead extensible across consumer, industrial, civic, medical, financial, and defense-grade devices. This broad compatibility promotes future-proof coverage, allowing newly developed devices (e.g., implantable, quantum terminals, NIL trackers, hologram projectors) to serve as activation points without redesigning the core system.

By embedding the activation logic into AI-driven orchestration, binding results to blockchain provenance, and securing them with quantum-resistant cryptography, the system 100, 300 establishes a global, unified authentication layer capable of scaling with emerging ecosystems, regulatory requirements, and cross-industry standards, such as ISO 20022 financial messaging and QKD key exchange.

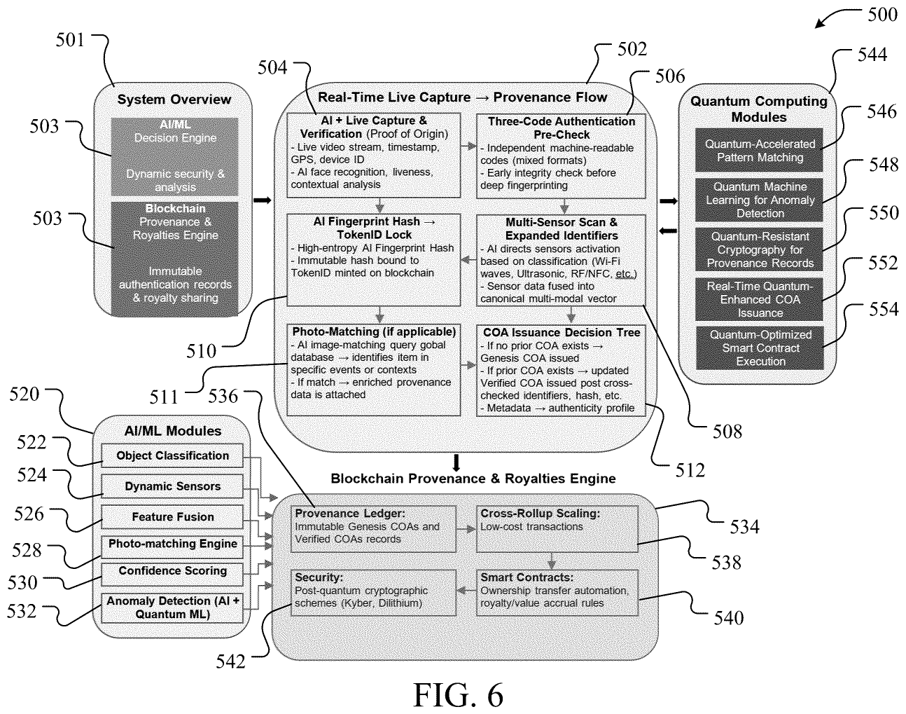

Referring to FIG. 6, in some embodiments an AI-driven authentication and provenance tracking system 500 integrates multi-sensor analysis, DNA/material signature profiling, blockchain-anchored provenance records, and quantum-enhanced computation modules. Artificial Intelligence (AI) serves as the primary decision engine and security orchestrator, dynamically selecting the appropriate sensor modalities and authentication pathways for different categories of tangible items (e.g., leather, textiles, plastics, jewelry, wood, ceramics, metals). Blockchain functions as the provenance and royalties engine, anchoring immutable Certificates of Authenticity (COAs), ownership transfers, and royalty/value-sharing mechanisms. Quantum Computing modules serve as the accelerator and optimizer, providing quantum-accelerated pattern recognition, anomaly detection, cryptographic resilience, and optimization of smart contract execution.

As shown in FIG. 6, the Real-Time Live Capture and Provenance Creation Flow 502 can execute a multi-stage pipeline when an item (or information) enters the authentication process. The process proceeds as follows.

At step 504 (i.e., 1), AI and Live Capture & Verification (i.e., Proof of Origin) are completed. For example, a live video stream can be captured with timestamp, GPS coordinates, and device ID. AI modules can perform face recognition, liveness verification, and contextual analysis (e.g., confirming the act of signing or handing over the item). The resulting data becomes the “Proof of Origin”input.

At step 506 (i.e., 2), an Authentication Pre-Check commences. For example, a three-code authentication pro-check can include three independent machine-readable codes (e.g., QR, NFC, serial, holographic, or mixed formats), which are validated in parallel. This step ensures an early integrity check before deeper fingerprinting occurs.

At step 508 (e.g., 3), Multi-Sensor Scan and Expanded Identifiers are completed: AI directs which sensors to activate, based on item classification. Example modalities include Wi-Fi wave reflection, Ultrasonic pulse resonance, RF/NFC signature response, Thermal imaging, Optical/UV/IR spectroscopy, DNA tagging or chemical taggants, Microtext, holograms, tamper-evident seals, watermarks, and/or OVI inks. Sensor data can be fused into a canonical multi-modal vector.

At step 510 (i.e., 4), AI Fingerprint Hash and TokenID Lock commences. For example, the canonical vector can be reduced to a high-entropy AI Fingerprint Hash. This hash can be immutably bound to a TokenID minted on blockchain, forming the final authoritative lock.

At step 5, Photo-Matching Step occurs (if applicable). AI image-matching modules can query global databases of photos/videos to identify whether the item (e.g., jersey, glove, ball) appears in specific events or contexts. If a match is found, enriched provenance data (e.g., game/event metadata) can be attached.

At step 512 (i.e., 6), a COA Issuance Decision Tree is entered. If no prior COA exists, then the Genesis COA is issued. If a prior COA exists, then an updated Verified COA is issued after cross-checking identifiers, hash, and blockchain provenance. Metadata can include live video proof, timestamp, GPS, sensor data, identifier records, fingerprint hash, TokenID, and optional photo-match references.

At step 514 (i.e., 7), Blockchain Provenance Anchoring and ISO 20022 & Codex/Index occurs. The COA record can be immutably stored on Ethereum rollups (e.g., Arbitrum, Base, Optimism) with periodic anchoring to Ethereum L1. Metadata can persist in decentralized storage (e.g., IPFS/Arweave). Blockchain anchoring can create immutable storage on L2 rollups (e.g., Arbitrum, Base, Optimism) with periodic anchoring to Ethereum L1. ISO 20022 Integration can ensure every provenance write generates an ISO 20022-compliant event message (e.g., payments, transfers, settlements) for direct compatibility with banks and regulators. In some embodiments, a Codex/Index Layer ensures each COA write also appends GAAP/IFRS accounting codex entries, IRS/tax codex records, and industry compliance indexes (e.g., energy credits, securities, medical, etc.) to ensure audit-ready traceability. Dual Anchoring can be used to write provenance data both to blockchain and codex/index stores, ensuring traditional compliance and decentralized proof.

At step 516 (i.e., 8), Smart Contract Activation and Allocation & Minting occurs. Upon COA issuance, a smart contract can be linked to the TokenID. This can govern ownership transfer, value accrual across resales, and allocation of benefits in the royalties system. In some embodiments, an Allocation Module can use smart contract logic allocates royalty inflows dynamically across multiple wallets (e.g., creators, investors, reserves, tax escrow). Programmable Reserve Pools can ensure a defined percentage is routed automatically to a reserve fund (i.e., reserve-funded) that backs ecosystem coin issuance. In some embodiments, a Minting Module can be used, whereby for each authenticated royalty inflow, the system mints ecosystem coins/tokens linked to the TokenID lineage and provenance hash. These can act as asset-backed instruments tied to real royalty streams. In some embodiments, Quantum Optimization is used, whereby smart contract execution and minting transactions are quantum-optimized (e.g., latency reduction, secure QKD signing).

At Step 518 (i.e., 9), Ongoing Verification/Resales and Reporting occurs. Re-Scan & Provenance Match can Continue AI and multi-sensor rescans at every resale event. Royalty Redistribution can be used, whereby an Allocation engine re-triggers, minting more ecosystem tokens if applicable. In some embodiments a Reporting Module can be used to Emit ISO 20022 audit and settlement messages to financial networks; Generate codex-indexed GAAP/IFRS ledgers and IRS/tax reports; Produce CPA-certified outputs for compliance, regulators, and investors; and/or Post blockchain-anchored audit reports and traditional accounting reports in parallel (i.e., dual compliance).

As shown in FIG. 6, the system includes Artificial Intelligence and Machine Learning (“AI/ML”) modules 520. The AI infrastructure incorporates multiple layers of decision-making and security. For example, Object Classification 522 can be included to detect whether the item is textile, leather, plastic, paper, jewelry, etc. Dynamic Sensor Selection 524 can be included to choose the optimal combination of Wi-Fi/ultrasonic/RF/thermal/DNA scans. Feature Fusion 526 can be included to convert heterogeneous inputs into unified multi-modal feature vectors. A Photo-Matching Engine 528 can be included to query indexed photo/video databases for context verification. Confidence Scoring 530 can be included to produce probabilistic authentication scores, with human-AI hybrid review on flagged items. Anomaly Detection (AI+Quantum ML) 532 can be included to detect inconsistencies, tampering, or cloned identifiers.

Additionally, or alternatively, the following AI/ML Modules can be further included. Regulatory Codex Mapping AI can utilize an AI engine to dynamically map provenance events to codex/index entries (e.g., GAAP, IFRS, IRS tax codes, SEC securities reporting) and/or produce structured audit outputs ready for ISO 20022 message generation. Allocation Optimization AI can include predictive ML models to determine optimal royalty allocation percentages between creators, investors, reserve funds, and escrow wallets. This feature can support dynamic adjustment based on contractual terms, jurisdiction, or asset performance. Minting Control AI can be included to use AI to govern when and how ecosystem tokens are minted, ensuring issuance only upon validated provenance and royalty inflows. This process can use anomaly detection to block fraudulent or duplicate minting triggers. Reporting Intelligence can be included. For example, A Natural Language Generation (NLG) layer can be included that produces CPA-ready financial summaries, regulator dashboards, and ISO 20022-compatible settlement reports. AI can learn from prior filings (e.g., SEC/IRS accepted formats) to pre-validate reports before submission. Adaptive Compliance Learning can be included to continuously monitor changes in accounting standards, tax codes, and ISO 20022 schemas and/or automatically update codex mappings and smart contract parameters without human intervention. An Explainable AI (XAI) Layer can be included to provide human-auditable reasoning for major authentication, allocation, and reporting decisions and/or generate machine-readable and human-readable logs that can be submitted to auditors or regulators.

As shown in FIG. 6, the system includes a Blockchain Provenance & Royalties Engine 534. A Provenance Ledger 536 can be included to ensure an immutable record of Genesis COAs and Verified COAs. Cross-Rollup Scaling 538 can be included to ensure transactions occur on Arbitrum, Base, and Optimism for low gas fees, with periodic anchoring to Ethereum L1. Smart Contracts 540 can be included to automate ownership transfer, enforce royalty/value accrual rules, and support fractionalized ownership if applicable. Security 542 can be included. For example, post-quantum cryptographic schemes (e.g., Kyber, Dilithium) can ensure COAs remain verifiable in a quantum-capable future.

The system can further include an ISO 20022 Messaging Layer. For example, every blockchain write (e.g., COA issuance, transfer, royalty payment) can generate a corresponding ISO 20022 message. Example Messages include <pacs.008> for payments, <semt.017> for asset transfers, and <auth.026> for authentication/audit events. This provision can ensure interoperability with global financial institutions, central banks, and tax authorities. The system can also include Codex/Index Anchoring, such as parallel anchoring of blockchain provenance data into GAAP/IFRS accounting codices and IRS/tax indexes. This provision can provide dual compliance, such as immutable blockchain and traditional codex-based ledgers. Additionally, or alternatively, CPA audits and regulator reviews can be enabled without requiring blockchain expertise. The system can also include a Royalty Allocation Engine that can be embedded within smart contracts to distribute royalty inflows automatically to creators, investors, reserve pools, and/or tax escrow accounts. Allocation percentages can be dynamically updated via governance or regulatory triggers. The system can further include Programmable Reserve Pools & Minting, whereby a fraction of royalties automatically pools into reserve smart contracts. These reserves back the issuance of ecosystem coins or tokens. Minted tokens can be cryptographically linked to TokenID provenance records, creating asset-backed digital instruments. Reporting Integration can also be included. For example, blockchain events can trigger real-time reporting to regulators, investors, and auditors. Reports can be generated in both ISO 20022 format and codex-indexed ledgers. This provision can support CPA-certified reports, government filings, and investor dashboards. The system can further include Quantum-Optimized Execution. For example, royalty distribution and minting transactions can leverage quantum optimization for efficiency. Additionally, alternatively, smart contracts can use QKD/post-quantum signatures for future-proof security.

As depicted in FIG. 6, the system includes Quantum Computing Modules 544. In the embodiment shown, the system integrates five quantum components. Quantum-Accelerated Pattern Matching 546 speeds similarity searches across global provenance/photo databases. Quantum Machine Learning for Anomaly Detection 548 ca use hybrid quantum-classical models to identify subtle tampering or forgery patterns. Quantum-Resistant Cryptography for Provenance Records 550 can utilize PQC and, in some embodiments, QKD for securing COA signatures. Real-Time Quantum-Enhanced COA Issuance 552 can use quantum processors to reduce COA validation latency during high-volume live events. Quantum-Optimized Smart Contract Execution 554 can Improve efficiency and throughput of contract settlement on Layer-2 rollups.

The system depicted by FIG. 6 can cooperate with a diverse Hardware and Sensor Infrastructure. For example, the system is compatible with Edge Devices such as IoT scanners, mobile devices, and/or embedded chips. Sensor Fusion Gateways such as Wi-Fi/ultrasonic/RF/DNA scanners can connect and synchronize with the system. High-Throughput Servers, such as GPU/TPU/quantum co-processors for AI and quantum jobs are also compatible with the system. In some embodiments, latency is considered by the system, such as round-trip times for live capture to blockchain anchoring.

In some embodiments, the system can include a Network and Communication Layer. For example, Edge-to-Cloud Data Flow can be included with suitable bandwidth requirements, compression, and encryption in transit. Quantum Communication Links such as QKD channels, fiber and/or satellite quantum key distribution can also be included. The system ca also include Resilience and Redundancy measures to establish fallback paths if one network fails.

In some embodiments the system can include Security and Cryptography features. For example, Post-Quantum Cryptographic Protocols can include key sizes, and/or signature schemes (e.g., Kyber, Dilithium). Secure Multiparty Computation (MPC) can be included for shared verification of provenance across nodes. Hardware Security Modules (HSMs) can be included to protect keys on edge devices.

In some embodiments, the system includes Scalability and Load Balancing. For example, Containerized Microservices can include Kubernetes/Hyperledger for blockchain modules. Load Distribution can be provided across AI inference engines, provenance ledgers, and ISO 20022 gateways. Throughput Targets can also be established, for example transactions per second (TPS) for L2 rollups, photo-matching database queries, and ISO messaging.

In some embodiments, the system includes Data and Storage Architecture. For example, On-Chain and/or Off-Chain Partitioning can be used to determine what stays on blockchain and/or decentralized storage (e.g., IPFS/Arweave). Indexing Services can be included to provide metadata codex linking COA records to accounting/tax codices. Retention Policies can also be included, such as audit logs, compliance archives, and/or sensor raw data retention periods.

In some embodiments, the system includes Compliance and Governance Infrastructure. For example, Access Controls can be included to identity management for auditors, regulators, creators, and/or investors. Regulatory Gateways can be included to provide automated interfaces to IRS, SEC, and/or central banks. Governance Nodes can be included that define quorum/consensus for COA validation and/or smart contract parameter updates.

In some embodiments, the system includes Monitoring and Maintenance. For example, Health Checks can be included to provide uptime monitors for sensors, blockchain nodes, and/or quantum processors. Adaptive Updates can be included to provide automated compliance rule updates pushed to smart contracts. Incident Response can be included to provide rollback protocols in case of provenance mismatch or sensor failure.

As illustrated by the embodiment of FIG. 6 and as described above the system utilizes AI as its “brain to direct live capture analysis, dynamic multi-sensor selection, anomaly detection, fingerprint generation, and/or provenance verification. The system uses Blockchain as the Provenance Engine, which anchors immutable COAs, ensures transparent ownership/value transfer, and enforces royalty rules through smart contracts. The system further utilizes Quantum as the Accelerator and Security Layer to deliver speed, cryptographic resilience, anomaly detection accuracy, and smart contract optimization for high-volume environments. I some embodiments, the system can employ Compliance-Embedded Architecture. For example, by integrating ISO 20022 messaging, GAAP/IFRS codex entries, and/or IRS/tax reporting, the system is natively audit-ready, bridging decentralized provenance with centralized financial and regulatory ecosystems. The system can also include Programmable Financialization. For example, the Royalty allocation modules, programmable reserve pools, and minting engines can convert authenticated royalty flows into asset-backed digital instruments, creating ecosystem coins directly tied to provenance and COAs. In some embodiments, Dual-Layer Reporting is included, whereby every transaction produces both blockchain-anchored audit trails and codex-indexed financial ledgers, enabling simultaneous compliance with decentralized verification and traditional accounting/auditing standards. The system can also provide Self-Adaptive Compliance. For example, AI modules can continuously learn from changes in tax codes, ISO schemas, and regulatory updates, ensuring the system remains forward-compatible without manual intervention.

In some embodiments, the system (as depicted by FIG. 6) includes Unified AI-Blockchain-Quantum Architecture to integrate said three normally siloed domains into a single authentication and financialization pipeline to enable dynamic sensor control, real-time provenance validation, and quantum-secure transaction execution. Hardware-Software Synergy can combine edge IoT sensors, GPU/TPU/quantum accelerators, and blockchain nodes into a layered infrastructure to ensure low-latency live capture and robust provenance anchoring across diverse physical environments. Scalable Multi-Layer Provenance can include dual anchoring into blockchain and codex/index frameworks to ensure both decentralized immutability and traditional GAAP/IFRS audit readiness, which can support large-scale throughput e.g., (millions of items/events) with modular scaling across Layer-2 rollups. The system ca further include Quantum-Resilient Security to employ PQC (e.g., Kyber, Dilithium) and QKD-secured signatures for future-proof authenticity. Additionally, or alternatively, the system can leverage quantum-enhanced ML for anomaly detection and fraud prevention at global scale. The system can also include Programmable Financialization & Royalties to convert royalty streams into asset-backed ecosystem tokens, unlocking new forms of fractionalized value. Additionally, or alternatively, smart contracts can automatically allocate flows to creators, investors, reserve pools, and tax escrows. In some embodiments, the system has Native Compliance Integration, whereby each provenance event generates ISO 20022-compliant financial messages for seamless bank and regulator interoperability. Additionally, or alternatively, parallel codex anchoring can produce IRS/tax-ready, GAAP/IFRS-certified ledgers for audit and reporting. In some embodiments, the system can include Adaptive Governance and Self-Healing Compliance. For example, AI modules ca auto-update mappings when tax codes, accounting standards, or ISO schemas evolve. Additionally, or alternatively, Governance nodes ca enable jurisdiction-specific parameter tuning without halting the system. In some embodiments, the system can include Operational Transparency and Explainability. For example, XAI (i.e., Explainable AI) can produce human-readable and machine-readable audit trails that can enhance regulator trust, CPA certification, and/or investor confidence by making all AI decisions auditable. The system can further include End-to-End Lifecycle Assurance. For example, continuous re-scan and re-verification across resale cycles can ensure provenance integrity over time, and the dual reporting layer ca provide simultaneous assurance to decentralized ecosystems and centralized authorities.

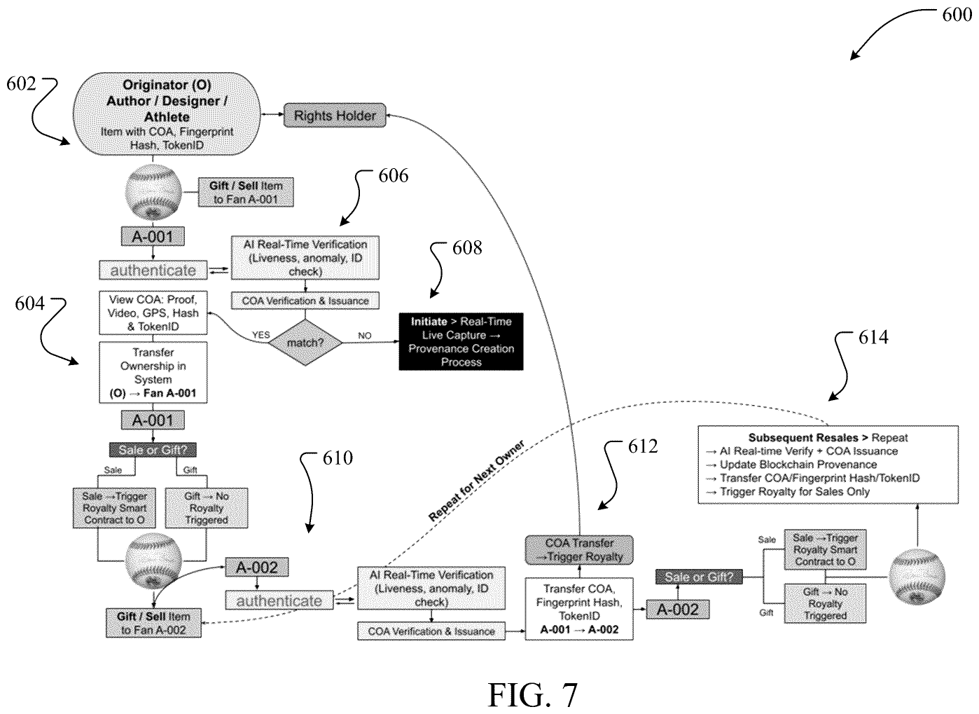

Referring to FIG. 7, a method 600 is provided that applies the system 300 to an example memorabilia authentication and tracking use case. As shown in FIG. 7, Real-Time Live Capture with Provenance Creation Flow is integrated into the AI-Enhanced Provenance, Decentralized Authenticity, and Royalties Ecosystem. In this embodiment, an Originator (denoted “O,” such as an Author, Designer, Athlete, or Artist) at 602 gifts an autographed memorabilia item (e.g., a baseball) to a first collector, designated A-001. Upon transfer at 604, the system initiates AI-enhanced verification at 606 using a smartphone, AR glasses, or VR headset. The process includes face recognition, liveness detection, and quantum-assisted anomaly detection to confirm the Originator's identity, along with multi-sensor scanning (e.g., high-resolution imaging, ultrasonic pulse signatures, RF/NFC reads, thermal snapshot) to verify the item. If the item already possesses a Certificate of Authenticity (COA), AI Fingerprint Hash, and TokenID, these records are displayed and authenticated for A-001, and ownership is updated on the blockchain. If no prior COA or TokenID exists, the system prompts A-001 to initiate a genesis capture process at 608 that includes video Proof-of-Origin, Three-Code Authentication, multi-sensor data fusion, computation of an AI Fingerprint Hash, and TokenID binding secured through quantum-enabled cryptography and key management.

Once ownership is established, A-001 may retain, gift, or sell the item. A gift transfer does not trigger royalty execution, while a sale at 610 automatically activates the royalty-enabled smart contract, which directs a predefined royalty percentage to the Originator's Rights Holder account at 612. The blockchain provenance is updated, and the COA/Fingerprint Hash/TokenID mapping is reassigned to the new owner, A-002. Subsequent transfers (e.g., A-002→A-003→A-004, etc.) follow the same Real-Time Live Capture→Provenance Creation Flow, including AI real-time verification, COA issuance, blockchain provenance updates, COA/Fingerprint Hash/TokenID transfers, and automated royalty disbursements on sales.

At each transfer stage 614, every verified collector (e.g., A-001, A-002, A-003, A-004, etc.) is also “crowned” as a member of The Legacy Circle: Perks and Rewards Ecosystem, thereby becoming part of the Originator's legacy. Legacy Circle members are granted exclusive benefits, including VIP access and events, ownership recognition, digital badges, personalized content, community participation, and unique experiential rewards. Thus, each authenticated memorabilia item not only carries immutable provenance and automated royalty enforcement but also creates a fan-engagement ecosystem that grows as the item changes hands. The flow further demonstrates integration of quantum modules at key stages: (i) quantum-assisted anomaly detection during real-time verification, (ii) quantum-accelerated pattern matching for multi-sensor and photo-matching authentication, and (iii) quantum-enabled cryptography and key management for final COA signing and TokenID security.

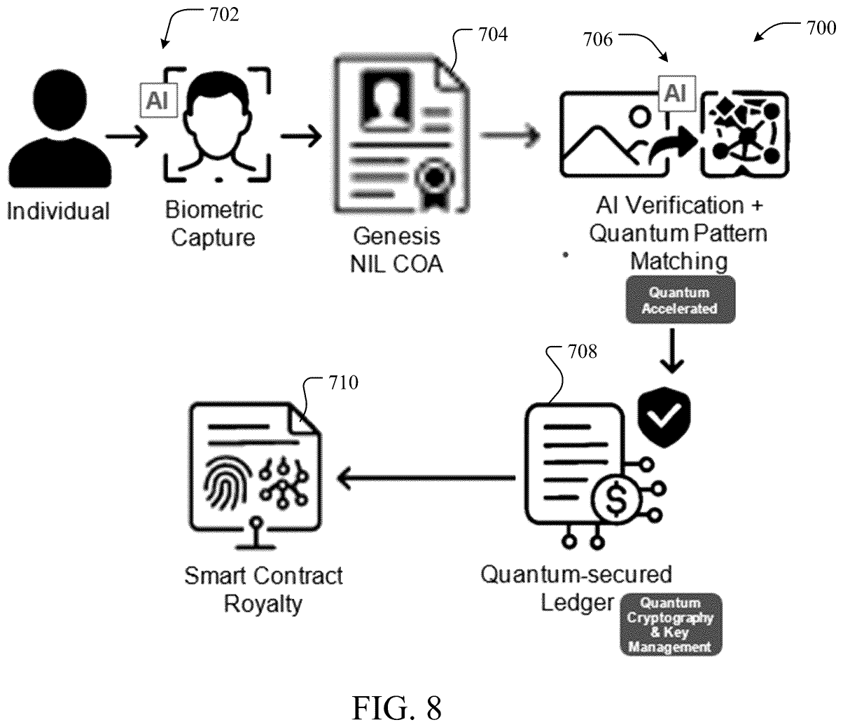

Referring to FIG. 8, a method 700 to authenticate and track individuals'biometric identities, such as their Name, Image, and Likeness (“NIL”) is provided. In the depicted steps, authenticated recognition and automated lifetime royalty distribution is tracked whenever a person's NIL is used, reproduced, or shared across media, events, or digital platforms.

For example, the method 700 can be used for athletes, entertainers, public figures, professionals, and ordinary individuals whose biometric profile is authenticated and tokenized. The method creates a walking revenue royalty stream by linking NIL authentication to blockchain-backed provenance and royalty contracts.

As depicted in FIG. 8, the method 700 proceeds as follows. At Step 702 (i.e., 1), Real-Time Biometric Capture & NIL Enrollment occurs. At any life stage (e.g., birth, youth, adulthood, retirement), individuals can enroll by capturing multi-sensor biometric data. The biometric data can include, for example, facial scan, voiceprint, gait recognition, Iris, fingerprint, and DNA signature (optional), or any combination thereof. AI-driven NIL profile generation can bind all identifiers into a unique biometric fingerprint hash.

At Step 704 (i.e., 2), AI Fingerprint Hash & Blockchain Provenance commences. At step 2, biometric NIL data is fused into an AI fingerprint hash, establishing a Genesis NIL COA (Certificate of Authenticity for identity). The NIL COA can include Visual video+3D/4D profile, Geo+timestamp of enrollment, Name+authorized digital signature, and/or Ownership lineage (individual and heirs).

At Step 706 (i.e., 3), NIL Usage Authentication occurs. Each time a person's NIL is detected in use (e.g., news coverage, social media tagging, event broadcast, advertisements), AI image/voice recognition verifies authenticity. The System then checks if use aligns with licensed/authorized rights.

At Step 708 (i.e., 4), Royalty Smart Contract Execution proceeds. If NIL usage is verified, smart contracts automatically allocate royalties to the individual. Royalties flow in real time across multiple use cases, such as media appearances (news, TV, streaming), social media shares and/or viral content, event broadcasting (e.g., sports, concerts), advertisements or brand endorsements, and/or historical archival reuse (films, documentaries, biographies).

At Step 710 (i.e., 5), Quantum Integrations are performed. Module 1 can include Quantum-accelerated multi-sensor pattern matching, which scales biometric recognition to millions of NIL detections across global platforms in real time. Module 2 can include Quantum-powered anomaly detection, which identifies impersonations, deepfakes, or fraudulent NIL use with unmatched precision. Module 3 can include Quantum-enabled cryptography, which future-proofs NIL COAs, ownership lineage, and royalty contracts against quantum computing threats.

The output of the foregoing method 700 is a tamper-proof NIL provenance system from birth to retirement. As a result, a lifetime royalties stream can be tied to NIL use across all industries and platforms. Fraud prevention against impersonations, deepfakes, or unauthorized NIL use can also result. In some embodiments the system is Inheritance-ready, whereby heirs may continue to receive NIL royalties after death.

In sum, the system treats NIL as a tokenized, authenticated digital asset, introduces a Genesis NIL COA (e.g., biometric+AI verified, blockchain-secured, quantum-protected), includes Scalable global NIL authentication using quantum-accelerated pattern matching, enforces royalties on every NIL usage event automatically via smart contracts, and extends NIL protection across entire lifetime and posthumous rights.

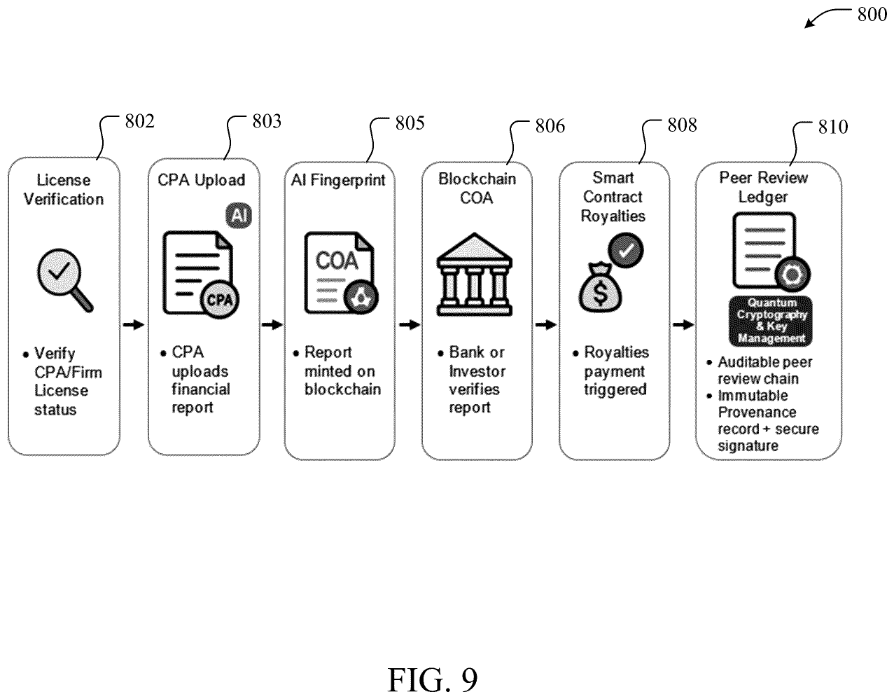

Referring to FIG. 9, a method 800 is provided to use the AI authentication, blockchain provenance, and royalty system for Certified Public Accountant (CPA) financial reports or for reports prepared by one who renders accounting services for compensation. The method 800 provides immutable authentication of CPA-prepared reports (e.g., audits, reviews, compilations, tax filings, financial statements, projections) through AI fingerprinting and blockchain storage, secured with quantum-resistant cryptography. A license verification module ensures the active status of the CPA and/or CPA firm prior to report authentication, promoting compliance with professional regulations. Smart contracts ensure that each use of an authenticated report in funding, lending, regulatory, or investment contexts automatically triggers a royalty payment to the originating CPA. The method 800 further establishes an auditable peer review custody chain, fraud detection engine, and consortium-based accounting ecosystem, thereby preventing reuse fraud, enhancing compliance, and providing ongoing CPA monetization.

The example method 800 depicted by FIG. 9 can provide immutable, tamper-proof reports, automated royalty compensation to CPAs, AI-driven fraud detection and condition comparison (e.g., text/numerical mismatches), license verification for CPAs and firms before authentication, and quantum-resistant encryption protecting long-term auditability.

As depicted by FIG. 9 the method 800 proceeds as follows. At step 802 (i.e., 1), CPA/Firm License Verification occurs. When a CPA submits a report, the system verifies the active license status of the CPA and/or CPA firm against official state and regulatory databases (e.g., Texas State Board of Public Accountancy, AICPA, PCAOB). Verification metadata (license number, jurisdiction, expiration, disciplinary status) can be bound to the report submission. Reports cannot proceed to authentication if the CPA's license is inactive, revoked, or expired.

At step 804 (i.e., 2), AI+Blockchain Authentication commences. After license verification, the CPA can upload a financial report 803. AI can parse content (e.g., text, figures, formatting) into a unique fingerprint hash 805. A blockchain-backed Genesis COA 806 is minted for the report, ensuring immutability and provenance.

At step 808 (i.e., 3), a Smart Contract Royalty Engine is called. Each time a verified report is used for funding, underwriting, or compliance, a smart contract executes royalty disbursement to the originating CPA. Royalties are tied to real-world funding or investment events.

At step 808 (i.e., 4), Fraud Detection and AI Matching occurs. AI cross-checks new submissions against prior reports. Duplicate or unauthorized reuse is detected and flagged. Mismatches between authenticated and newly submitted data are also flagged.

At step 810 (i.e., 5), Peer Review Custody Chain begins. Peer reviewers can query the blockchain ledger of all CPA-issued reports. This step ensures no fraudulent concealment of reports during peer review.

The method 800 promotes a Consortium-Based Accounting Platform. For example, businesses can integrate with a shared ecosystem of bookkeepers, CFOs, CPAs, and auditors. All CPA-generated outputs are immutably recorded for funding, regulatory, and investor confidence. Reports can follow specific and controlled workflow. For example, reports can flow from bookkeepers to CFO to CPA. Each CPA submission can first pass license verification, then enter blockchain provenance.

The method 800 can further employ Quantum-Resistant Security. Reports and metadata (including license verification) are secured with quantum-resistant encryption, which guarantees forward security against quantum computing threats.

The method 800 can be suitable for Bank Loan Authentication. For example, a CPA can issue a review report. The system can verify the CPA license status, then authenticate the report via blockchain. Banks can query ledger for authenticity. Upon funding, smart contract pays royalties.

The method 800 is also suitable for Investment Due Diligence. For example, CPA-validated projections can be checked for license validity, authenticated, and reused across investor pitches. Royalties can be triggered each time a funded deal occurs.

The method 800 promotes Peer Reviewed Integrity. For example, the blockchain ledger ensures reviewers access all reports tied to a CPA's verified license, preventing omissions.

The method's integrated CPA License Verification Layer (at step 802) ensures that only actively licensed CPAs/firms can issue authenticated blockchain reports, the Royalty model for CPAs via smart contracts ensures CPAs are compensated when their work product is used at all stages (absent in conventional accounting practice), the immutable blockchain custody of CPA reports, prevents concealment or tampering, AI fingerprinting of text/numerical data can be used to detect and/or prevent fraud, Quantum-resistant security can be applied to financial reporting, and the integrated consortium model can replace siloed accounting software.

While the method 800 described above using a CPA(or equivalent) as an example, in alternative embodiments the method 800 can be applied to other wok work product generated by professionals in other industries. For example, the method 800 can be applied to professional-generated work product by doctors lawyers, engineers, architects, etc.

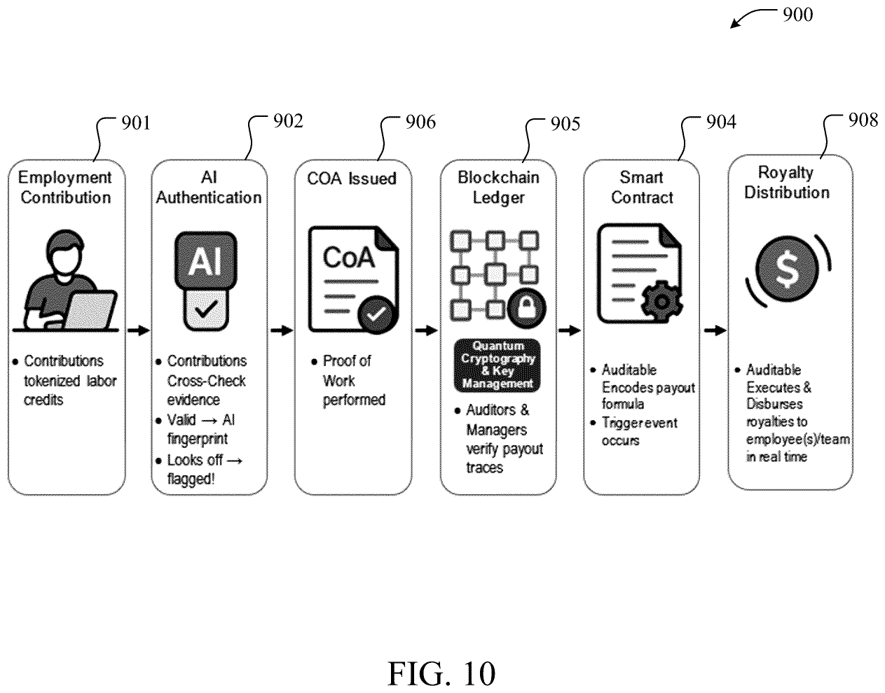

Referring to FIG. 10, a method 900 is provided for applying the authentication and tracking system to workforce compensation. The method 900 can replace or supplement wage-per-hour models and/or salary compensation models with AI-authenticated, blockchain-verified, royalty allocations linked to employee contributions. For example, each unit of verified labor (e.g., production output, service interaction, sales transaction, professional deliverable) can be authenticated in real time, issued a blockchain-backed Certificate of Authenticity (CoA), and tied to a smart contract defining royalty terms. Royalties can be automatically distributed to employees or contributors proportionally to verified outputs. This method 900 creates a transparent, tamper-proof compensation framework, secured with quantum-resistant cryptography, that links labor directly to enterprise value.

As depicted by FIG. 10, the method 900 proceeds as follows. At step 902 (i.e., 1), the AI Authentication Layer commences. AI validates labor contributions in real time using, for example, ERP, CRM, POS, IoT, or workflow data. Examples of workflow data can include units assembled, hours logged, sales closed, customer interactions, software code deployed.

At step 904 (i.e., 2), the Employment Smart Contracts are utilized. Employment contracts can be digitized into smart contracts. Terms define royalty allocation formulas (e.g., % per unit produced, % per sale closed, % per audit completed).

A step 906 (i.e., 3), Certificates of Authenticity (CoA) are generated. Each verified contribution generates a CoA tied to an employee, for example by an ID and timestamp.

Immutable blockchain entries links labor contribution to enterprise value.

At step 908 (i.e., 4), Royalty Distribution Engine initiates. Smart contracts distribute royalties in real time upon verification of outputs. The method can replace conventional static payroll cycles with continuous, authenticated payouts.

The method 900 can tokenize Business Outputs. For example, contributions can be tokenized as labor credits or tradable business output units. Employees may hold, trade, or monetize these tokens, enabling ESOP-like participation.

The method 900 can have Quantum-Resistant Security. All employment CoAs, contracts, and payouts can be secured using quantum-resistant cryptographic algorithms to ensure long-term auditability and fraud prevention.

The method 900 can be used for Manufacturing. For example, each unit assembled can be authenticated with IoT sensors+AI. CoA logged. Smart contracts can pay royalties per part produced. The method 900 can be sed for Retail. For example, POS can confirm customer transactions. A service CoA can be issued accordingly. Royalties can flow to the cashier and support staff per verified customer served. The method 900 can be sed for Sales. For example, a CRM can log a closed deal. AI can validate the transaction. Smart contracts can pay commission royalties, preventing double-commission fraud. The method 900 can be used for Professional Services. For example, when an accountant or engineer produces deliverable, a CoA is issued, and a royalty paid based on the terms of a smart contact. If the work product is reused later, royalties automatically flow to the originator. The method 900 can be used or Software development. For example, if a Developer commits a feature to production, AI can verify deployment. The CoA can be logged, and Royalties can be allocated per feature released.

The method 900 can promote transparency because every contribution is tied to a blockchain-authenticated CoA. The method promotes fairness because employees are rewarded based on measurable impact. The method promotes Fraud Resistance because AI verification prevents ghost work (i.e., wage theft), duplicate claims, or payroll manipulation. The method promotes Flexibility because Hybrid models are possible (e.g., base wage with royalties). The method promotes future proofing because Quantum-resistant security ensures long-term trust.

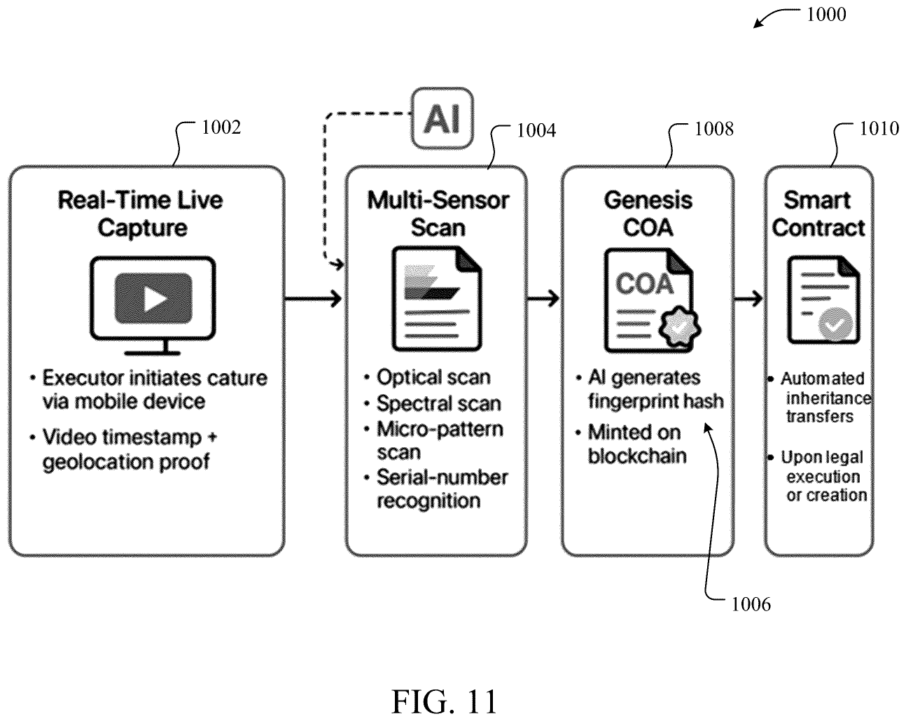

Referring to FIG. 11, a method 1000 is provided for applying the authentication and tracking system to ensure secure authentication, provenance creation, and automated transfer mechanisms for family heirlooms and inherited assets. The method 1000 can proceed as follows.

At step 1002 (i.e,, 1), during estate planning or probate execution, the executor, notary, or family member can initiate a Real-Time Live Capture using the system's mobile or embedded device application. At step 1004 (i.e., 2), the item can be scanned using multi-sensor capture (e.g., optical, spectral, micro-pattern, and/or serial-number recognition), combined with video timestamp and geolocation proof. At step 1006 (i.e., 3), the system can generate an AI Fingerprint Hash, uniquely binding the heirloom to its provenance record. At step 1008 (i.e., 4), a Genesis COA can be minted on the blockchain and recorded as part of the estate ledger. At step 1010 (i.e., 5), inheritance transfers may be automated via smart contracts, ensuring that upon legal execution or creation of a will or trust, ownership is reassigned to designated beneficiaries in a tamper-proof and transparent manner.

The result of the foregoing method can be a permanent, immutable blockchain record of heirloom ownership and transfer, resistant to tampering or fraudulent claims, and admissible as digital proof of authenticity in estate proceedings.

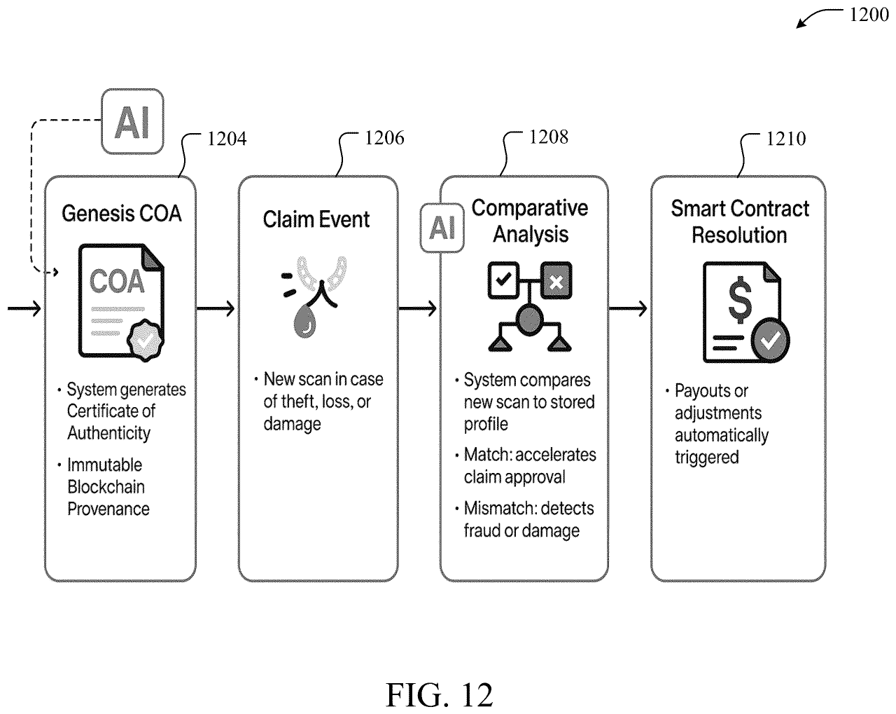

Referring to FIG. 12, a method 1200 is provided for applying the authentication and tracking system such that it integrates with insurance providers to authenticate insured items, reduce fraud, and accelerate claims processing. The method 1200 can proceed as follows.

At step 1202 (i.e., 1), Baseline Capture commences. At the time of insuring an item, the policyholder can perform Real-Time AI+Multi-Sensor Capture (e.g., video, 3D scan, infrared, timestamp, geolocation). This establishes a baseline provenance and condition record.

At step 1204 (i.e., 2), the Genesis COA is created. The system generates a Genesis Certificate of Authenticity (COA) linked directly to the policy, with Immutable Blockchain Provenance as evidence of authenticity and condition at inception.

At step 1206 (i.e., 3), the Claim Event occurs. In case of theft, loss, or damage, the insurer or claimant can perform a new scan.

At step 1208 (i.e., 4), Comparative Analysis commences. The system compares the new scan against the stored AI Fingerprint Hash and condition profile. A Match result confirms identity and condition remain unchanged; accelerates claim approval. A Mismatch result indicates Fraud or Substitution. An anomaly detection is triggered, flagging possible counterfeit substitution or fraud attempt. Alternatively, a Mismatch can indicate a condition change (e.g., Damage Recognition): AI can detect defects, such as cracks, discoloration, missing parts, or other physical degradations. The system can automatically initiate a damage valuation protocol, producing an objective, timestamped condition-change record.

At step 1210 (i.e., 5), Smart Contract Resolution occurs. Payouts, partial settlements, or damage adjustments may be automatically triggered via smart contracts once conditions are verified.

The method 1200 provides fraud-resistant, condition-aware insurance verification that can reduce risk exposure for insurers, accelerate claim approvals for policyholders, and create a tamper-proof damage audit trail for future resale or inheritance purposes.

In both the inheritance method 1000 of FIG. 11 and the insurance method 1200 of FIG. 12, provenance records and transfers can be secured with Quantum-Resistant Encryption and Anomaly Detection modules, ensuring forward security even in the presence of future quantum computing threats. This safeguards critical legal and financial asset transfers beyond conventional cryptography lifespans.

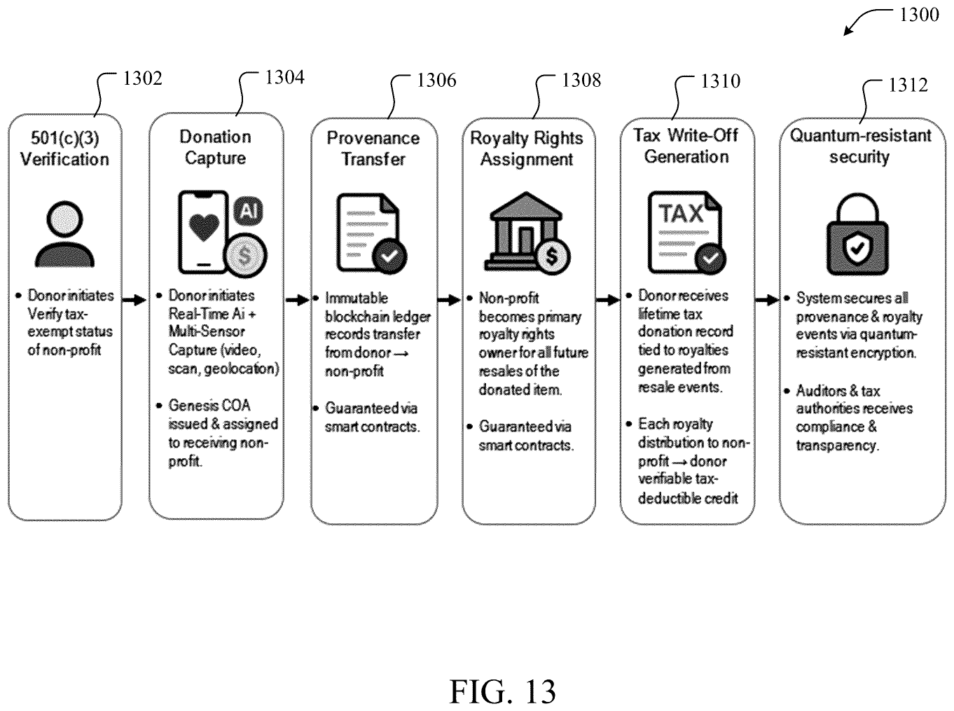

Referring to FIG. 13, a method 1300 is provided to apply the authentication and tracking system to charitable donations of memorabilia, collectibles, and art, allowing donors to contribute high-value assets to non-profit organizations while leveraging blockchain provenance, AI authentication, quantum-resistant security, and automated royalty streams. As depicted in FIG. 13, the method 1300 proceeds as follows.

At Step 1302 (i.e., 1), Non-Profit Status Verification occurs. Before donation capture, the system verifies the tax-exempt legal status of the receiving organization. For U.S.-based charities, the system can query official IRS databases (e.g., IRS Exempt Organizations Business Master File) to confirm active 501(c)(3) recognition. For international non-profits, the system can integrate with recognized global registries (e.g., UN NGO database, Charity Commission for England and Wales, OECD/International equivalents). Verification metadata (e.g., organization name, registration number, jurisdiction, status, expiration, disciplinary or compliance notes) can be logged into the blockchain record. Donations cannot proceed without verified, active charitable status.

At Step 1304 (i.e., 2), Donation Capture occurs. A donor can initiate Real-Time AI and Multi-Sensor Capture (e.g., video, scan, geolocation) to authenticate the memorabilia at the moment of donation. A Genesis COA can be issued and assigned to the receiving non-profit organization.

At Step 1306 (i.e., 3), Provenance Transfer occurs. The Immutable Blockchain Ledger can record the transfer from donor to the non-profit, creating a permanent provenance link.

At Step 1308 (i.e., 4), Royalty Rights are Assigned. The non-profit becomes the primary royalty rights owner for all future resales of the donated item, guaranteed via smart contracts.

At Step 1310 (i.e., 5) Tax Write-Off Generation occurs. The donor can receive a lifetime tax donation record tied to royalties generated from resale events. Each royalty distribution to the non-profit provides the donor with additional, verifiable tax-deductible credit (i.e., structured as a recurring charitable tax expense).

The method 1300 includes Quantum-Resistant Security 1312. The system secures all provenance and royalty events with quantum-resistant encryption to protect donor, non-profit, and resale records against future computing threats.

The method 1300 further promotes positive Long-Term Impact. Non-profits benefit from sustainable recurring revenue streams. Donors receive a lifetime tax benefit, dynamically updated as royalties accrue. Auditors and tax authorities receive a tamper-proof, blockchain-anchored record of all donation-linked transactions, ensuring compliance and transparency. The output of the method can be a dual-benefit system where non-profits are empowered with perpetual royalty income, and donors are incentivized through lifetime tax write-offs, creating a self-sustaining philanthropic ecosystem driven by authenticated, provenance-secured assets.

The method 1300 is beneficial because integration of 501(c)(3) and global non-profit verification tools ensures that only qualified charitable organizations can participate, blockchain provenance and AI authentication prevents fraud in charitable donations, smart contract royalties create recurring donor-linked tax benefits, a model absent in conventional philanthropy systems, and/or quantum-resistant encryption ensures long-term integrity of charitable records.

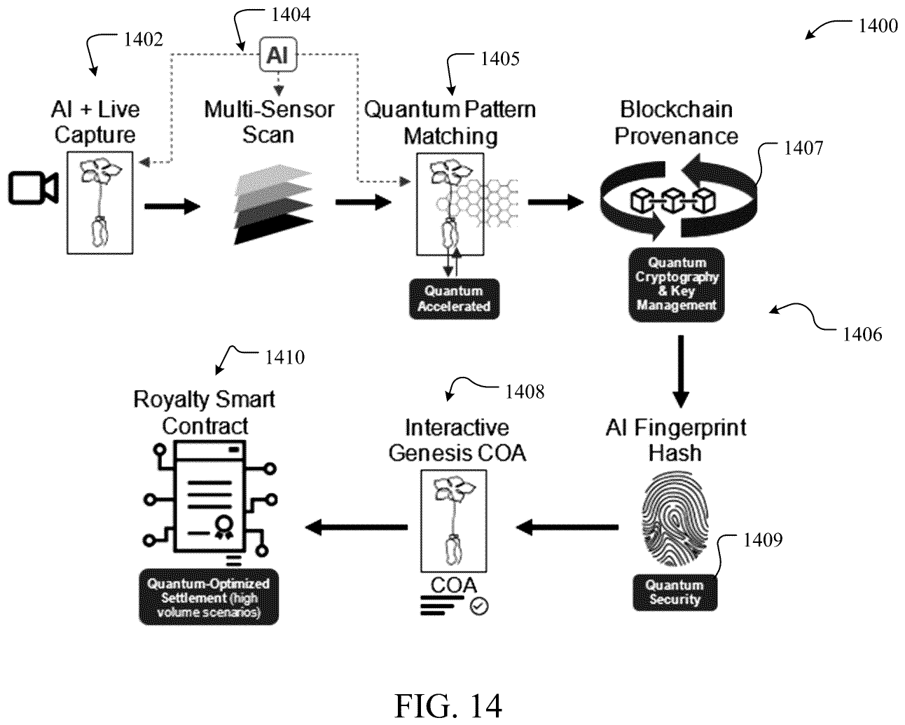

Referring to FIG. 14, a method 1400 is provided to apply the authentication and tracking system to visual arts including paintings, drawings, printmaking, sculpture, ceramics, architecture, photography, film, design arts, and textile/fiber arts. The system can provide real-time AI authentication, blockchain provenance creation, interactive Genesis COAs, and automated royalty distribution secured by quantum-resistant cryptography. This method aims to ensure artists, collectors, museums, galleries, and secondary-market participants benefit from tamper-proof provenance records, recurring royalties, and scalable fraud prevention. As depicted in FIG. 14, the method 1400 proceeds as follows.

At Step 1402 (i.e., 1), Real-Time Live Capture (Proof of Origin) occurs. A user, for example an artist, can initiate capture using a device, such as a mobile device, AR glasses, or studio camera. Continuous video can embed metadata, such as a timestamp, geolocation, and device ID. Verbal confirmation can also be included (e.g., artist states name, date, context) stored in additional metadata.

At Step 1404 (i.e., 2), AI Multi-Sensor Capture & Expanded Identifiers commence. Artworks can be scanned with multiple sensors based on medium. For example, Paintings & Drawings can be scanned using UV/IR/XRF imaging, pigment & fiber analysis, micro-pattern brushstroke capture. Printmaking can be scanned using pressure mark scans, ink layering, plate mapping. Sculptures & Ceramics can be scanned using 3D LiDAR, ultrasonic resonance profiles, and/or thermal/glaze chemical fingerprint. Architecture & Design can be scanned using CAD hashing, RFID/NFC material tagging. Photography & Film can be scanned using EXIF metadata locks, image noise patterning, frame hashing. Textiles & Fiber Arts can be scanned using dye spectral scans, 3D thread mapping, and/or weave pattern imaging. In some embodiments, Quantum Module 1, Scalable Authentication 1405, is used, whereby multi-sensor data is processed through quantum-accelerated pattern matching, enabling real-time authentication across millions of artworks.

At Step 1406 (i.e., 3), AI Fingerprint Hash 409 & Blockchain Provenance 407 commences. Sensor data can be fused into a multi-modal AI fingerprint hash. Hash can be minted as a TokenID and linked to blockchain (i.e., blockchain-linked). Provenance records can include artist ID, geo/time stamps, and sensory signatures. In some embodiments, Quantum Module 2, Fraud Detection, is implemented, whereby Quantum-powered anomaly detection can identify irregularities (e.g., deepfake forgeries, microscopic alterations, pigment mismatches). This module Enhances precision of fraud detection beyond classical AI.

At Step 1408 (i.e., 4), Genesis COA Creation (Interactive & Viewable) occurs. The system generates a Genesis COA as a video and 3D/4D interactive artifact, accessible via mobile or AR/VR. The Genesis COA contains Live video of creation/signing event, Virtual 3D/4D model of artwork, Geo/time/date stamp, Artist metadata and digital signature, Expanded identifiers and sensor data, Ownership lineage (i.e., current & prior owners), Valuation history (e.g., sale prices, appraisals), and/or Embedded royalty structures. Access can be controlled by cryptographic keys (e.g., public viewers see simplified confirmation, authorized stakeholders see full record).

At Step 1410 (i.e., 5), Royalty Smart Contracts commences. Each resale, exhibition, or licensed use triggers automatic royalty payments back to the artist or estate. Contracts can be embedded within the COA metadata.

The method 1400 includes Quantum-Resistant Security. In some embodiments, Quantum Module 3 is provided, which includes Genesis COAs, fingerprint hashes, and royalty contracts are secured using quantum-resistant encryption. This module ensures long-term integrity of provenance records against future quantum computing threats.

The output of the method 1400 is a living, interactive provenance artifact viewable by collectors, fans, and regulators and a tamper-proof blockchain COA that integrates ownership lineage and valuation. Artists can gain recurring royalties across secondary and tertiary markets. Collectors and institutions can gain verifiable authenticity for insurance, tax, and resale. The system scales globally, processing millions of artworks in real time.

The method 1400 combines real-time AI capture and multi-sensor scans and interactive Genesis COA; embeds ownership lineage and valuation history within an accessible provenance artifact; introduces quantum-accelerated pattern matching for global authentication scalability; leverages quantum anomaly detection to improve fraud detection; and/or secures provenance and royalties with quantum-resistant cryptography.

In another embodiment, a method 1500 (not shown) applies the authentication and tracking system to entertainment, media, and fan-engagement verticals. The Genesis COA can be leveraged not only for provenance and royalties but also for interactive, gamified experiences.

This embodiment can apply, for example, to sports highlights, tickets, music performances, esports/gaming assets, e-sport asset, and literary works, each benefiting from tamper-proof provenance, ongoing royalties, and immersive fan engagement. The method can proceed as follows.

At Step 1502 (i.e., 1), Real-Time Live Capture (Event or Creation) occurs. For Sports applications, this step can include capturing live highlights (e.g., home run, dunk, touchdown) with embedded video, geo/time stamp. For Music applications, this step can include capturing live concert moments (e.g., song performance, backstage signing). For Gaming applications, this step can include capturing esports plays or unlocking digital in-game achievement. For Literature applications, this step can include capturing author signing or live manuscript scan. The foregoing are exemplary applications only and are not intended to be limiting.

At Step 1502 (i.e., 2), Multi-Sensor Capture occurs. For Sports and/or Music applications, this step can include high-definition video+audio+venue metadata. For gaming applications this step can include screen recording+server logs+player authentication. For literature applications, this step can include multi-spectral imaging of paper/ink+author verification.

At Step 1504 (i.e., 3), AI Fingerprint Hash & Blockchain Provenance occurs. Each captured moment or item can be fused into a multi-modal fingerprint hash. The Blockchain ledger can record provenance, including event metadata, creators/performers, and geo/time data.

At Step 1506 (i.e., 4), Genesis COA Creation (Interactive & Gamified) occurs. The COA ca be generated as video+3D/4D artifact, viewable via mobile, desktop, AR/VR. The COA can contain Proof-of-Origin video of event or signing, Expanded identifiers (e.g., venue data, device logs, spectral signatures); Ownership lineage across resales; Valuation history (e.g., market resale prices, appraisals); Embedded royalty structure for originators. The Gamification Layer can further include COAs that may unlock exclusive AR/VR replays, behind-the-scenes footage, or “level-up” perks (e.g., fan leaderboards, Legacy Circle membership, access to bonus content).

At Step 1508 (i.e., 5), Royalty Smart Contracts commences. Smart contracts can provide royalties to originators (e.g., athletes, musicians, authors, game developers) upon resale, licensing, or sharing of the Genesis COA-linked content.

The method 1500 includes Quantum Security Modules. In some embodiments, the method includes Module 1, whereby Quantum-accelerated multi-sensor pattern matching scales NIL/artwork authentication to millions of assets in real time. In some embodiments, the method includes Module 2, whereby Quantum-powered anomaly detection flags fraudulent media manipulation (e.g., deepfakes, tampered highlights). In some embodiments, the method includes Module 3, whereby Quantum-enabled cryptography secures provenance and royalties against quantum threats.

The output of the method 1500 allows sports fans to own interactive Genesis COAs tied to specific plays or ticketed experiences; music fans to access authenticated concert memories and royalties-based collectibles; gamers to hold provenance-secured in-game items and esports highlights; and/or readers/collectors to own COAs tied to first editions, novels, manuscripts, or comic originals with immutable provenance and resale royalties.

The method 1500 expands Genesis COA from authentication to fan engagement and gamification, creates living, interactive COAs as revenue streams for creators, players, and performers, introduces AR/VR unlockables, leaderboards, and perks tied directly to COA ownership, and/or integrates quantum-enabled modules for scale, fraud resistance, and future-proof security.

In another embodiment, a method 1600 (not shown) applies the authentication and tracking system to act as a compensation engine. The method can proceed as follows. At step 1602 (i.e., 1), Multi-Sensor Inputs and Identifier Collection commences. At this step, inputs can be captured in real time. Examples of inputs include biometric scan, NIL credential, cannabis seed-to-sale record, audit log, defense part ID, and/or IoT device log. At step 1604 (i.e., 2), an Authentication Engine process occurs. The authentication engine can convert inputs to a non-reversible, salted authentication token. The authentication engine can further apply a pattern-protection firewall so AI models cannot repurpose identifiers. At step 1606 (i.e., 3), Authentication Token Creation occurs. A unique, one-time cryptographic hash with embedded watermark can be created. In some embodiments, the token can be linked to blockchain (i.e., blockchain-linked) for immutability and provenance. At step 1608, (i.e., 4), Compensation Engine Activation commences. Once a token is recorded, the Compensation Engine smart contract can calculate the appropriate payout. For example, compensation can be royalties, fees, shares, or indemnities.

Exemplary Compensation Categories (i.e., Industry Examples) can include Voting & Governance, whereby auditors, election officers paid upon validation; Tax and Compliance, whereby CPAs receive fees and/or regulators receive compliance payments; Financial, whereby lenders/lessors receive automated lease, buyout, or interest payments; Medical/Cannabis, whereby dispensaries/pharmacies receive authenticated payment shares and/or regulators receive excise taxes; NIL, such as athletes, artists, or workers can be auto-paid royalties when NIL is used/resold; Supply Chain/Property, whereby owners/insurers can be compensated upon recovery of stolen property; Government/Security, whereby clearance auditors receive payment upon authenticated approval; Retail, whereby rands receive resale royalties on authenticated consumer goods; Energy; whereby producers receive PPA payments and/or carbon credit trade royalties; telecom/IoT, whereby network operators can be compensated for authenticated IoT transactions; Education; whereby Universities receive licensing fees for diploma verification; Insurance, whereby payouts flow to policyholders upon authenticated claims; Entertainment/Metaverse, whereby creators receive resale royalties in digital marketplaces; defense/Industrial, whereby contractors can be compensated for authenticated delivery of parts; CPA/Regulatory, whereby audit fees can be auto-disbursed to reviewers/regulators; Medical Peer Review, whereby physicians can be compensated for authenticated trial reviews; egal Peer Review, whereby arbitrators/judges receive verified arbitration fees; and/or Smart Cities, whereby municipalities, utilities compensated for authenticated service usage (e.g., tolls, energy, water).

At step 1610 (i.e., 6), the distribution layer commences. For example, payments can be disbursed instantly via smart contract. In some embodiments, the distribution layer supports multi-party distribution (e.g., NIL resale sends 70% to athlete, 20% to platform, 10% to regulator). Additionally, or alternatively, the distribution layer can be compatible with fiat, stablecoins, CBDCs, or tokenized credits.

As related to any of the systems and methods for authentication and tracking described above, compensation and/or royalties can be non-monetary. Non-monetary “compensation” can include intrinsic value and/or social value associated with acts. For example, the authentication and tracking system can support charitable or nonprofit initiatives. In this case, authenticated data can represent verified good deeds, donations, and/or community impact metrics. In some embodiments, the system can track “random acts of kindness” to supporting measurable positive impact through AI authentication.

As related to any of the systems and methods for authentication and tracking described above, the system is not limited to tangible or monetary items. For example, in some embodiments, the system can track and authenticate experiences. User experiences can include events, volunteer hours, mentorship sessions, educational activities, and/or artistic performances. The user experiences can be verifiable through AI analysis (e.g., video, sensor data, metadata) and recorded on the blockchain as authenticated provenance data.

These additions expand the invention from physical item-based value tracking to human-impact and experience-based tracking, while maintaining the same AI authentication, verification, and metric-generation framework described in the original application.

There are many industry uses for the system 100, 300. For example, the system can be used to authenticate and tract memorabilia, art, fashion/luxury goods, music and entertainment gaming and literature, and/or financial and legal assets. Memorabilia can include sports memorabilia such as a live game home run ball with instant Genesis COA, stadium metadata+augmented reality (“AR”) replay. Art uses can include Proof-of-Origin video signing with dynamic COA viewable in AR. Fashion/Luxury Goods uses can include DNA tagging with hologram identifiers and royalty-linked resale. Music/Entertainment uses can include unlockable content tied to resale COAs. Gaming & Literature uses can include interactive Genesis COAs for limited editions with AR story unlocks. Financial and Legal Asset uses can include inheritance verification, insurance claims, and CPA-certified financial reports anchored to provenance records.

Target users of the authentication and tracking system 100 and method 200 may include collectors, fans, supporters, aficionados, connoisseurs, and followers (i.e., individuals and organizations that collect high-value items, including memorabilia, art, digital assets, fashion, luxury goods, music and entertainment); artists, musicians, athletes, creators, innovators, performers, designers, and visionaries (i.e., originators who want to ensure their work is authenticated and receive ongoing royalties from future sales); cannabis growers (i.e., producers who want to authenticate their products and track them through the supply chain, ensuring quality and regulatory compliance); real estate investors (i.e., those involved in buying, selling, and managing real estate assets who need a secure and transparent platform for transactions); and dealers and retailers (i.e., businesses that specialize in selling collectibles, art, cannabis, or real estate, requiring reliable authentication and tracking tools).

Additional target industries of the authentication and tracking system 100 and method 200 may include sports, art and collectibles, fashion and luxury goods, music and entertainment, real estate and licensing. In particular, in the sports industry, athletes can earn royalties on the resale of signed memorabilia, jerseys, or equipment, with a system in place to ensure authenticity and track ownership history. Collectible sports cards also provide an opportunity for both collectors and athletes to benefit from royalties on the resale of rare or limited-edition cards, with blockchain technology 108 verifying their authenticity. Event merchandise is another revenue stream, as teams, leagues, and athletes can receive royalties from the resale of official event merchandise, with the authentication and tracking system 100 ensuring proper tracking of authenticity.

In the art and collectibles market, artists can receive royalties every time their artwork is resold, with the authentication and tracking system 100 ensuring accurate tracking of ownership and provenance. Creators or issuers of collectible coins and stamps can also benefit from royalties on resales, with proper authentication to ensure trust in the market. Historic and celebrity memorabilia offer another opportunity for celebrities, public figures, and historic estates to earn royalties on the resale of iconic or significant personal items, with the authentication and tracking system 100 verifying authenticity and tracking ownership history to maintain value and trust.

In the fashion and luxury goods sector, designers can earn royalties on secondary market sales of their creations, with the authentication and tracking system 100 verifying the items and prevent counterfeiting. For limited-edition sneakers, brands or designers can receive royalties on resales, with blockchain technology 108 ensuring that the sneakers are genuine and their ownership history is accurately tracked. Additionally, luxury brands and fashion icons can monetize limited-edition or historically significant fashion pieces by earning royalties on resales, with the authentication and tracking system 100 confirming authenticity and provenance.

In the music and entertainment industry, musicians and producers can earn royalties on sales and resales of digital music, particularly in the growing NFT space, with the authentication and tracking system 100 managing digital rights and ownership. Filmmakers and content creators can also earn royalties on resales or usage of their digital content, with the authentication and tracking system 100 in place to ensure fair compensation and prevent unauthorized distribution. Similarly, artists and entertainers can receive royalties on the resale of memorabilia, such as signed instruments, costumes, or movie props, with the authentication and tracking system 100 providing authentication and tracking ownership.

In real estate, property owners can earn ongoing royalties from the sale of fractional ownership, with a system in place to ensure transparency and fair distribution of returns. Historical real estate items, such as property deeds, blueprints, or architectural artifacts, can also be sold with ongoing royalties on resales, with the authentication and tracking system 100 ensuring authenticity and tracks ownership changes over time.

The licensing of software and digital products allows developers to earn royalties based on usage or resales, with the authentication and tracking system 100 tracking distribution and ensuring compliance with licensing agreements. Additionally, software companies and digital creators can monetize signed or rare editions of physical or digital products, earning royalties on resales, with the authentication and tracking system 100 in place to ensure authenticity and proper tracking.

These industries can all benefit from adopting a royalty model that generates ongoing revenue streams, enhancing trust, transparency, and security through the authentication and tracking system 100. By including memorabilia in this model, companies and creators can create new opportunities for monetization and deeper engagement with fans, collectors, and consumers, adding value across various sectors.

It should be appreciated that the term “originator” or “athlete” encompasses a wide range of a wide range of creators and innovators, including iconic authors, composers, influencers, performers, designers, visionaries, sports athletes, and artists. The term “buyer”, “owner” or “collector” encompasses not only those who purchase and collect memorabilia but also fans, supporters, aficionados, connoisseurs, followers, and sports enthusiasts.

Further, the term “autograph” can include alternative marks that our AI-powered (including manual or tech/software devices used) authentication and tracking technology capturing marks similar to “autograph” for various types of items like memorabilia, collectibles, art, music and entertainment, real estate, fashion and luxury goods, and software products.

For example, for memorabilia and collectibles: a signature (a handwritten name or mark from the creator or owner, commonly used for items like sports memorabilia); an inscription; (a personal message or note written on the item, often more detailed than a simple signature); a marking (a unique identifying symbol or name left by the creator or previous owner); an authentication stamp (a seal or mark that verifies the authenticity of the item); or an endorsement (a personal validation, often from a notable figure, which can add value to the item).

For art: an artist's signature (the name or symbol the artist uses to sign their work); an edition number (a number indicating the specific print or copy in a limited series of artworks); provenance (a documented history of the ownership and origin of the artwork, often verifying its authenticity); a seal (a stamp or embossing used by the artist or a certifying body to authenticate the piece); or a monogram (a stylized signature, often involving initials, used by the artist).

For music and entertainment: signed memorabilia (an item bearing the signature of a celebrity or musician); handwritten lyrics (original or reproduced lyrics written by the artist); a certified copy (an official reproduction of an original item, often signed or authenticated by the artist); or a limited edition (a version of an item that is produced in a small, numbered quantity, often signed or authenticated).

For real estate: a title deed (a legal document proving ownership, often signed by the current and previous owners); an endorsement letter (a formal letter signed by the previous owner or a notable figure associated with the property); an owner's signature (a signature on official documents like contracts or agreements, verifying ownership); or a seal of authenticity (a mark or stamp on property documents verifying their validity).

For fashion and luxury goods: personalized items (customized with a name, initials, or unique design); a designer's mark (a signature or identifying mark by the designer, often found on high-end goods); a certificate of authenticity (a document that verifies the genuine nature of the item, often accompanied by the designer's signature); a limited edition (a product created in a limited run, often with identifying numbers or signatures from the designer); or a monogram (initials or symbols that personalize or authenticate a luxury item).

For software products: a digital signature (an encrypted code that verifies the authenticity of the software or document); a code signing certificate (a digital certificate that authenticates the software and verifies the identity of the publisher); a unique identifier (UID, a specific code or number that authenticates the software); a developer's mark (an identifiable symbol or code left by the software developer); or an endorsement key (a security feature that authenticates the integrity of the software).

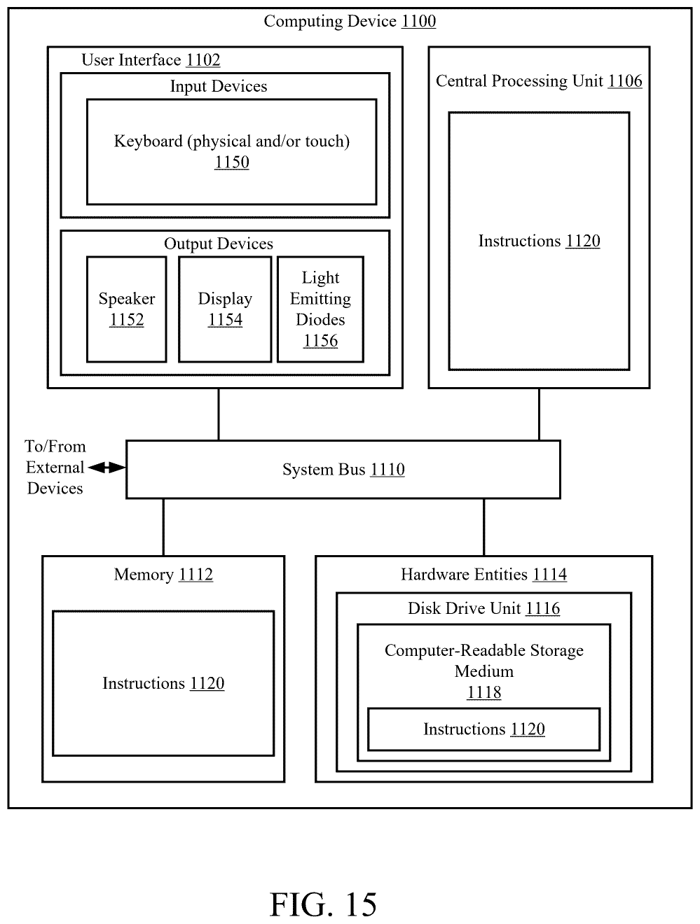

Referring to FIG. 15, an example computer architecture is shown, which may be used to implement processor-based embodiments of this disclosure. Any of the foregoing systems and/or methods may be adapted in a processor-based embodiment. As shown, a computing device 1100 may comprise a user interface 1102, a Central Processing Unit (“CPU”) 1106, a system bus 1110, a memory 1112 connected to and accessible by other portions of computing device 1100 through system bus 1110, and hardware entities 1114 connected to the system bus 1110. The user interface may comprise one or more input devices and output devices, which facilitate user-software interactions for controlling operations of the computing device 1100. The input devices include, but are not limited to, a physical and/or touch keyboard 1150. The input devices can be connected to the computing device 1100 via a wired or wireless connection (e.g., a Bluetooth® connection). The output devices may comprise, but are not limited to, a speaker 1152, a display 1154, and/or light emitting diodes 1156.

At least some of the hardware entities 1114 may be configured to perform actions involving access to and use of memory 1112, which can be a Random Access Memory (RAM), a disk driver and/or a Compact Disc Read Only Memory (CD-ROM), among other suitable memory types. Hardware entities 1114 can include a disk drive unit 1116 comprising a computer-readable storage medium 1118 on which is stored one or more sets of instructions 1120 (e.g., programming instructions such as, but not limited to, software code) configured to implement one or more of the methodologies, procedures, or functions described herein. The instructions 1120 can also reside, completely or at least partially, within the memory 1112 and/or within the CPU 1106 during execution thereof by the computing device 1100.

The memory 1112 and the CPU 1106 also can constitute machine-readable media. The term “machine-readable media”, as used here, refers to a single medium or multiple media (e.g., a centralized or distributed database, and/or associated caches and servers) that store the one or more sets of instructions 1120. The term “machine-readable media”, as used here, also refers to any medium that is capable of storing, encoding or carrying a set of instructions 1120 for execution by the computing device 1100 and that cause the computing device 1100 to perform any one or more of the methodologies of the present disclosure. According to various embodiments, one or more computer applications 1124 may be stored on the memory 1112.

In this document, an “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

The terms “processor” and “processing device” refer to a hardware component of an electronic device that is configured to execute programming instructions, such as a microprocessor or other logical circuit. A processor and memory may be elements of a microcontroller, custom configurable integrated circuit, programmable system-on-a-chip, or other electronic device that can be programmed to perform various functions. Except where specifically stated otherwise, the singular term “processor” or “processing device” is intended to include both single-processing device embodiments and embodiments in which multiple processing devices together or collectively perform a process.

As used herein, the term “royalties” can be interpreted broadly to include, without limitation, traditional royalties, such as recurring payments to rights holders based on use, resale, or reproduction of intellectual property, content, or credentials; licensing fees, such as one-time or recurring fees for permission to use an object, credential, or service (e.g., NIL, cannabis licensing, medical licensing, professional certifications); subscription fees, such as recurring payments for continued access to authenticated data, services, or systems; usage-based payments, such as per-scan, per-verification, per-transaction, or API-call fees for authentication services; revenue share, such as automatic allocation of revenue generated from resale, transfer, or secondary market transactions; audit fees, such as payments automatically triggered upon completion or approval of CPA peer review, government audits, IT audits, cannabis compliance audits, or inspector general reports; insurance payouts, such as automated compensation triggered by authenticated insurance claims, reinsurance contracts, or indemnity events; indemnity and restitution payments, such as compensation to victims, owners, or insurers upon recovery of stolen property, counterfeit goods, or defense assets; government fees and taxes, such as excise taxes, compliance fees, property taxes, or other statutory payments authenticated and collected via blockchain; compensation credits, such as non-cash equivalents, including tokens, points, credits, or vouchers distributed as part of compensation or settlement; and/or non-monetary forms, such as intrinsic social value associated with verified good deeds, donations, or community impact metrics.

As used herein, the term “authentication” can be interpreted broadly to include, without limitation, the process of verifying, validating, or confirming the identity, provenance, or legitimacy of any object, transaction, credential, service, or asset through multi-sensor input, identifiers, cryptographic transforms, or blockchain linkage.

As used herein, the term “Identifiers” can be interpreted broadly to include, without limitation, biometric data, multi-sensor input, images, video, sound, motion signatures, physical unclonable functions (PUFs), cryptographic keys, medical records, prescriptions, cannabis identifiers, NIL credentials, audit logs, government policies, defense asset identifiers, stolen property records, educational certifications, legal filings, IoT device identifiers, smart city logs, or financial instruments.

As used herein, the term “Pattern-Protection Layer” can be interpreted broadly to include, without limitation, a protective mechanism that prevents identifiers or authentication tokens from being used, derived, or reconstructed by artificial intelligence, including but not limited to synthetic AI, genetic AI, evolutionary AI, or other machine learning models. In some cases, this can include prohibiting one or more of training, pre-training, or fine-tuning; simulation, embedding, or inference extraction; and/or generative reproduction or derivative modeling.

As used herein, the term “compensation engine” can be interpreted broadly to include, without limitation, an automated smart contract-enabled mechanism that calculates, distributes, or enforces royalties, licensing fees, subscription fees, usage payments, revenue shares, indemnities, audit fees, insurance payouts, or other compensation.

This disclosure is not limited to the particular systems, methodologies or protocols described, as these may vary. The terminology used in this description is for the purpose of describing the particular versions or embodiments only and is not intended to limit the scope.

It will be understood that various modifications may be made to the embodiments disclosed in this document. Likewise, the above disclosed methods may be performed according to an alternate sequence. Therefore, the above description should not be construed as limiting, but merely as examples of the various embodiments. Those skilled in the art will envision other modifications within the scope and spirit of the claims appended to this document.

The described features, advantages, and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such a feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

What is claimed is:

1. A system for authenticating assets and distributing royalties, comprising:
a real-time capture module configured to record live creation, transfer, or performance events with an embedded geolocation and timestamp;
a multi-sensor authentication module configured to generate a fused fingerprint hash of the asset or performance using optical, spectral, acoustic, biometric, or digital data;
a first Certificate of Authenticity linked to the fused fingerprint hash and configured for entry on a blockchain ledger, the first Certificate of Authenticity including at least one of:
a video recording of the live capture event,
a multi-dimensional interactive model, and/or metadata including ownership lineage, valuation history, and/or royalty terms; and
a quantum security module configured to protect the first Certificate of Authenticity, and/or the fused fingerprint hash, using quantum-accelerated pattern matching, quantum-powered anomaly detection, and/or quantum-enabled cryptography.

2. The system of claim 1, wherein:
the first asset comprises memorabilia authenticated by real-time live capture; and
the memorabilia includes autographed items, event-worn apparel, game-used equipment, and/or cultural artifacts.

3. The system of claim 1, wherein:
the first asset comprises a collectible authenticated via multi-sensor scanning and blockchain provenance; and
the collectable includes trading cards, toys, figurines, and/or limited-edition merchandise.

4. The system of claim 1, wherein the first asset comprises a visual artwork authenticated using optical, spectral, and/or structural analysis; and
the visual artwork includes a painting, a drawing, a print, a sculpture, a ceramic, a photograph, and/or or a textile artwork.

5. The system of claim 1, wherein the first asset comprises a fashion work authenticated via weave pattern imaging, dye spectral scanning, and/or RFID/NFC tagging; and
the fashion work includes apparel, footwear, handbags, accessories, and/or couture pieces.

6. The system of claim 1, wherein the first asset comprises a luxury good authenticated via micro-engraving, optical variable ink, and/or material resonance profiling; and
the luxury good includes jewelry, watches, furniture, or interior design objects.

7. The system of claim 1, further comprising a smart contract engine configured to automatically distribute royalties upon resale, licensing, or usage of the first asset.

8. The system of claim 7, wherein the quantum security module is configured to protect royalty transactions.

9. The system of claim 7, wherein:
the first certificate of authenticity is linked to a sports highlight;
the sports highlight includes plays, scores, and/or ticketed events; and
the royalties are distributed to athletes, teams, or leagues upon resale and/or a licensed replay.

10. The system of claim 7, wherein:
the first certificate of authenticity is linked to a music performance;
the music performance includes a live concert, studio recording, and/or signed instrument; and
royalties are distributed to an originator and/or an estate of the originator upon resale and/or reuse.

11. The system of claim 7, wherein:
the first certificate of authenticity is linked to the first asset;
the first asset comprises a gaming and/or e-sports asset authenticated using server logs and/or player credentials; and
the gaming and/or e-sport asset includes digital skins, avatars, in-game achievements, and/or recorded highlight reels.

12. The system of claim 7, wherein:
the first certificate of authenticity is linked to the first asset;
the first asset comprise a literary or comic work authenticated using multi-spectral imaging and author signature capture; and
the literary or comic work includes a manuscript, a first edition, a novel, and/or an original illustration.

13. A method of authenticating assets and distributing royalties, comprising:
capturing, in real time, a creation or a transfer of a first asset or a first performance;
performing multi-sensor scanning of the first asset or the first performance;
generating a fingerprint hash;
creating a first certificate of authenticity linked to the fingerprint hash, wherein the first certificate of authenticity includes video, a three-dimensional or four-dimensional model, metadata including ownership lineage, a valuation history, and/or a royalty structure;
storing the first certificate of authenticity on a blockchain ledger; and
securing the first certificate of authenticity and/or the fingerprint hash using quantum-accelerated pattern matching, anomaly detection, and/or cryptography.

14. The method of claim 13, further comprising:
executing a smart contract to distribute royalties upon resale, licensing, and/or usage of the first asset or the first performance;
generating a royalty record; and
wherein the securing the first certificate of authenticity and/or the fingerprint hash further comprises securing the royalty record.

15. A computing device, comprising a processor and a memory configured to store programming instructions, wherein the programming instructions, when executed by the processor, are configured to cause the processor to cooperate with one or more devices to:
capture, in real time, a creation or a transfer, of a first asset or a first performance;
scan the first asset or first performance using a plurality of sensors;
generate a fingerprint hash;
create a first certificate of authenticity including video, a multi-dimensional model, metadata including ownership lineage, valuation history, and/or royalty structure;
store the first certificate of authenticity on a blockchain ledger; and
secure the first certificate of authenticity and/or the fingerprint hash using quantum-accelerated pattern matching, anomaly detection, and cryptography.

16. The device of claim 15, wherein the programming instructions, when executed by the processor, are further configured to cause the processor to cooperate with the one or more devices:
execute a smart contract to distribute royalties upon resale, licensing, and/or usage of the first asset; and
generate a royalty record, wherein the royalty record is secured using quantum-accelerated pattern matching, anomaly detection, and cryptography.

17. A method of authenticating an individual's name, image, and likeness (NIL), comprising:
capturing a first NIL that includes biometric data obtained using a plurality of sensors;
generating a first certificate of authenticity associated with the first NIL;
entering the first certificate of authenticity as an entry on a blockchain ledger;
identifying use of the first NIL across digital and/or physical platforms; and
distributing royalties to an originator by executing a smart contract.

18. The method of claim 17, further comprising using quantum-accelerated multi-sensor pattern matching when identifying use of the first NIL.

19. The method of claim 17, further comprising determining fraudulent use of the first NIL with quantum-powered anomaly detection.

20. The method of claim 17, further comprising securing the blockchain ledger and/or smart contracts with quantum-enabled cryptographic algorithms.

21. The method of claim 17, further comprising distributing royalties throughout a lifetime of the originator and assigning rights to the royalties posthumously.

22. A method of authenticating assets and allocating royalties, comprising:
initiating live capture of a first asset via one or more networked devices;
activating a plurality of sensors as directed by an artificial intelligence (AI) module based on asset classification;
capturing identifiers associated with the first asset;
generating a first multi-modal vector;
computing a first AI Fingerprint Hash using the first multi-modal vector;
determining a provenance record;
storing the first AI Fingerprint Hash and provenance record on a blockchain ledger secured by post-quantum cryptography; and
executing a smart contract to allocate royalties upon transfer, resale, or usage of the first asset.

23. The method of claim 22, wherein capturing the identifiers associate with the first asset includes capturing identifiers across physical, digital, chemical, biological, and/or cryptographic modalities.

24. The method of claim 22, wherein the initiating live capture of a first asset via one or more networked devices further comprises receiving capture data from a wearable device, the wearable device including a fitness tracker, a bodycam, smart clothing, or a smart contact lens.

25. The method of claim 22, wherein the initiating live capture of a first asset via one or more networked devices further comprises receiving capture data from an unmanned aerial vehicle.

26. The method of claim 22, wherein the initiating live capture of a first asset via one or more networked devices further comprises receiving capture data from a robotic platform and/or a cobot.

27. The method of claim 22, wherein the initiating live capture of a first asset via one or more networked devices further comprises receiving capture data from an industrial inspection device (e.g., borescope, handheld scanner, spectrometer, XRF).

28. The method of claim 22, wherein the initiating live capture of a first asset via one or more networked devices further comprises receiving capture data from an Interne of Things (IoT) device (e.g., smart hub, voice assistant, appliance).

29. The method of claim 22, wherein the initiating live capture of a first asset via one or more networked devices further comprises receiving capture data from a gaming and/or entertainment device.

30. The method of claim 22, wherein the initiating live capture of a first asset via one or more networked devices further comprises receiving capture data from a vehicle sensor platform (e.g., ADAS, telematics, lidar/camera).
